(19) United States
(12) Patent Application Publication
(10) Pub. No.: US 2016/0037184 A1
(43) Pub. Date: Feb. 4, 2016

(54) IMAGE PROCESSING DEVICE AND METHOD

(71) Applicant: SONY CORPORATION, Tokyo (JP)

(72) Inventor: Kazushi SATO, Kanagawa (JP)

(73) Assignee: SONY CORPORATION, Tokyo (JP)

(21) Appl. No.: 14/772,118

(22) PCT Filed: Mar. 5, 2014
(86) PCT No.: PCT/JP2014/055608

§ 371 Date: Sep. 2, 2015

(30) Foreign Application Priority Data
Mar. 14, 2013 (JP) 2013-051885

(51) Int. Cl. H04N 19/61; H04N 19/593; H04N 19/52; H04N 19/31; H04N 19/33

(52) U.S. Cl. CPC H04N 19/61; H04N 19/31; H04N 19/33; H04N 19/52; H04N 19/593

(57) ABSTRACT

Provided is an image processing device including: an in-screen search section configured to detect, with respect to an image of a lower layer of a current layer, a corresponding block which corresponds to a current block of the current layer and to perform an in-screen motion search on the detected corresponding block; and an intra prediction section configured to generate a predictive image of the current block using information of the in-screen motion searched for by the in-screen search section.

### TECHNICAL FIELD

The present disclosure relates to an image processing device and a method thereof, and particularly to an image processing device and a method thereof which enable coding efficiency in intra prediction of an upper layer to be improved.

### BACKGROUND ART

Recently, devices for compressing and encoding an image by adopting a encoding scheme of handling image information digitally and performing compression by an orthogonal transform such as a discrete cosine transform and motion compensation using image information-specific redundancy for the purpose of information transmission and accumulation with high efficiency when the image information is handled digitally have become widespread. Moving Picture Experts Group (MPEG), H.264, MPEG-4 Part 10 (Advanced Video Coding) (hereinafter referred to as AVC), and the like are examples of such encoding schemes.

Therefore, for the purpose of improving encoding efficiency compared to H.264/AVC, standardization of an encoding scheme referred to as high efficiency video coding (HEVC) by Joint Collaboration Team-Video Coding (JCTVC), which is a joint standardizing organization of International Telecommunication Union Telecommunication Standardization Sector (ITU-T) and International Organization for Standardization (ISO)/International Electrotechnical Commission (IEC), is currently in progress.

Meanwhile, the existing image encoding schemes such as MPEG-2 and AVC have a scalability function of dividing an image into a plurality of layers and encoding the plurality of layers.

In other words, for example, for a terminal having a low processing capability such as a mobile phone, image compression information of only a base layer is transmitted, and a moving image of low spatial and temporal resolutions or a low quality is reproduced, and for a terminal having a high processing capability such as a television or a personal computer, image compression information of an enhancement layer as well as a base layer is transmitted, and a moving image of high spatial and temporal resolutions or a high quality is reproduced. That is, image compression information according to a capability of a terminal or a network can be transmitted from a server without performing the transcoding process.

While intra 4×4 prediction, intra 8×8 prediction, and intra 16×16 prediction are present in AVC, angular prediction is applied to 4×4 to 64×64 pixel blocks in HEVC. Furthermore, planar prediction is defined in HEVC.

In addition, as intra prediction mode encoding methods, three most probable modes are used in HEVC.

However, when there is a region having a high correlation with a corresponding PU in regions that have already been encoded within the same picture, Non-Patent Literature 1 proposes referring to the region to improve encoding efficiency accordingly.

### CITATION LIST

### Non-Patent Literature

Non-Patent Literature 1: “Extended Texture Prediction for H.264/AVC Intra Coding” by Johannes Ball'e and Mathias Wien, ICIP 2007

### SUMMARY OF INVENTION

### Technical Problem

However, searching for such a region while performing an encoding process or a decoding process brings about an increase of a computation amount as described in the proposal of Non-Patent Literature 1.

It can be said that the same applies when an enhancement layer image encoding process and decoding process are performed while a scalable video coding process is performed.

The present disclosure takes the above circumstances into consideration, and aims to improve encoding efficiency of intra prediction of an upper layer.

### Solution to Problem

According to an aspect of the present disclosure, there is provided an image processing device including: an in-screen search section configured to detect, with respect to an image of a lower layer of a current layer, a corresponding block which corresponds to a current block of the current layer and to perform an in-screen motion search on the detected corresponding block; and an intra prediction section configured to generate a predictive image of the current block using information of the in-screen motion searched for by the in-screen search section.

A mode of the in-screen motion search may be used in encoding as one intra prediction mode of candidate predictions.

A method for the in-screen motion search may be block matching.

A search range of the in-screen motion search may be transmitted along with layer image encoded data obtained by encoding image data hierarchized into a plurality of layers.

The search range of the in-screen motion search may be transmitted in a sequence parameter set (SPS).

The search range of the in-screen motion search may be transmitted in a picture parameter set (PPS).

The search range of the in-screen motion search may be transmitted in a slice header.

The in-screen search section can perform an in-screen motion search on the corresponding block of the image of the lower layer that has not undergone up-sampling.

The in-screen search section can perform scaling on in-screen motion information obtained from the in-screen motion search, according to resolution of the current layer.

The in-screen search section can perform an in-screen motion search on the corresponding block of the image of the lower layer that has undergone up-sampling.

The in-screen search section can perform a search for decimal pixel accuracy when the in-screen motion search is performed on the corresponding block of the image of the lower layer.

An interpolation filter for motion compensation defined in an HEVC scheme may be used in the search for the decimal pixel accuracy.

The image may be an image of a luminance signal.

The image may be an image of a luminance signal and an image of a color difference signal, which may be processed separately.

The image may be an image of a luminance signal and an image of a color difference signal, and in-screen motion information detected using the image of the luminance signal may be used in processing of the image of the color difference signal.

The image may be images of a Cb signal and a Cr signal, which may be processed separately.

The image may be images of a Cb signal and a Cr signal, and in-screen motion information detected using the image of the Cb signal may be used in processing of the image of the Cr signal.

The information of the in-screen motion searched for by the in-screen search section may be transmitted along with layer image encoded data obtained by encoding image data hierarchized into a plurality of layers.

Differential in-screen motion information between the information of the in-screen motion searched for by the in-screen search section and information of an in-screen motion to be used in a decoding process may be transmitted along with layer image encoded data obtained by encoding image data hierarchized into a plurality of layers.

According to an aspect of the present disclosure, there is provided an image processing method including, by an image processing device: detecting, with respect to an image of a lower layer of a current layer, a corresponding block which corresponds to a current block of the current layer and performing an in-screen motion search on the detected corresponding block; and generating a predictive image of the current block using information of the in-screen motion that has been searched for.

According to an aspect of the present disclosure, with respect to an image of a lower layer of a current layer, a corresponding block which corresponds to a current block of the current layer is detected, an in-screen motion search is performed on the detected corresponding block, and a predictive image of the current block is generated using information of the in-screen motion that has been searched for.

Also, the above-described image processing device may be an independent device or an inner block constituting one image encoding device or image decoding device.

### Advantageous Effects of Invention

According to an aspect of the present disclosure, an image can be encoded or decoded. In particular, encoding efficiency of intra prediction of an upper layer can be improved.

### BRIEF DESCRIPTION OF DRAWINGS

FIG. 1 is a diagram for describing an example of a configuration of a coding unit.

FIG. 2 is a diagram for describing an example of spatial scalable video coding.

FIG. 3 is a diagram for describing an example of temporal scalable video coding.

FIG. 4 is a diagram for describing an example of scalable video coding of a signal to noise ratio.

FIG. 5 is a diagram for describing intra prediction of AVC and HEVC.

FIG. 6 is a diagram for describing planar prediction.

FIG. 7 is a diagram for describing an encoding scheme of an intra prediction mode.

FIG. 8 is a diagram for describing an in-screen motion search of intra prediction.

FIG. 9 is a diagram for describing the operation principle of the present technology.

FIG. 10 is a diagram illustrating an example in which a search range is limited.

FIG. 11 is a diagram illustrating another example of an in-screen motion search.

FIG. 12 is a block diagram illustrating an example of a main configuration of a scalable encoding device.

FIG. 13 is a block diagram illustrating an example of a main configuration of a base layer image encoding section.

FIG. 14 is a block diagram illustrating an example of a main configuration of an enhancement layer image encoding section.

FIG. 15 is a block diagram illustrating an example of a main configuration of an in-screen motion search section.

FIG. 16 is a flowchart for describing an example of a flow of an encoding process.

FIG. 17 is a flowchart for describing an example of a flow of a base layer encoding process.

FIG. 18 is a flowchart for describing an example of a flow of an enhancement layer encoding process.

FIG. 19 is a flowchart for describing an example of a flow of an intra prediction process.

FIG. 20 is a block diagram illustrating an example of a main configuration of a scalable decoding device.

FIG. 21 is a block diagram illustrating an example of a main configuration of a base layer image decoding section.

FIG. 22 is a block diagram illustrating an example of a main configuration of an enhancement layer image decoding section.

FIG. 23 is a block diagram illustrating an example of a main configuration of an in-screen motion search section.

FIG. 24 is a flowchart for describing an example of a flow of a decoding process.

FIG. 25 is a flowchart for describing an example of a flow of a base layer decoding process.

FIG. 26 is a flowchart for describing an example of a flow of an enhancement layer decoding process.

FIG. 27 is a flowchart for describing an example of a flow of a prediction process.

FIG. 28 is a flowchart for describing an example of a flow of an intra prediction process.

FIG. 29 is a diagram illustrating an example of a layer image encoding scheme.

FIG. 30 is a diagram illustrating an example of a multi-view image encoding scheme.

FIG. 31 is a block diagram illustrating an example of a main configuration of a computer.

FIG. 32 is a block diagram illustrating an example of a schematic configuration of a television device.

FIG. 33 is a block diagram illustrating an example of a schematic configuration of a mobile phone.

FIG. 34 is a block diagram illustrating an example of a schematic configuration of a recording/reproduction device.

FIG. 35 is a block diagram illustrating an example of a schematic configuration of an image capturing device.

FIG. 36 is a block diagram illustrating an example of using scalable video coding.

FIG. 37 is a block diagram illustrating another example of using scalable video coding.

FIG. 38 is a block diagram illustrating yet another example of using scalable video coding.

### DESCRIPTION OF EMBODIMENTS

Hereinafter, modes (hereinafter referred to as “embodiments”) for carrying out the present disclosure will be described. The description will proceed in the following order:

0. Overview

1. First embodiment (image encoding device)

2. Second embodiment (image decoding device)

3. Others

4. Third embodiment (computer)

5. Applications

6. Applications of scalable video coding

### 0. Overview

### [Encoding Scheme]

Hereinafter, the present technology will be described in connection with an application to image encoding and decoding of a High Efficiency Video Coding (HEVC) scheme.

### [Coding Unit]

In an Advanced Video Coding (AVC) scheme, a hierarchical structure based on a macroblock and a sub macroblock is defined. However, a macroblock of 16×16 pixels is not optimal for a large image frame such as a Ultra High Definition (UHD) (4000×2000 pixels) serving as a target of a next generation encoding scheme.

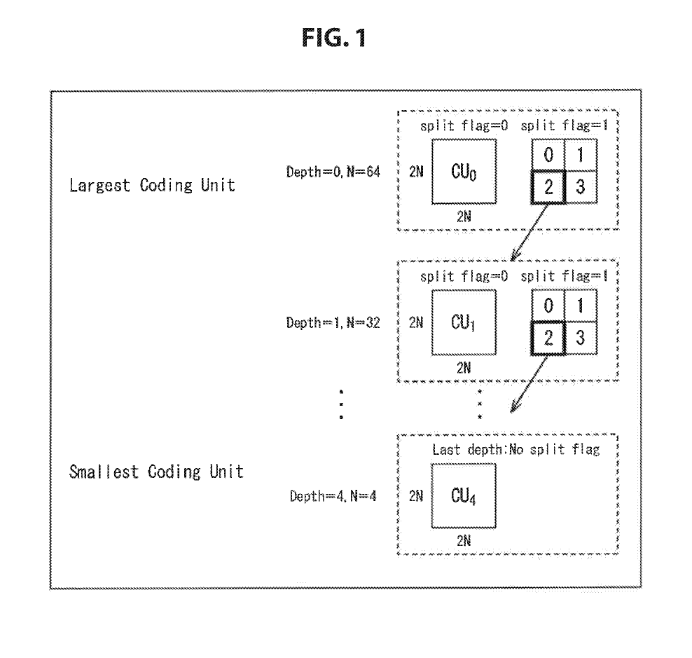

On the other hand, in the HEVC scheme, a coding unit (CU) is defined as illustrated in FIG. 1.

A CU is also referred to as a coding tree block (CTB), and serves as a partial area of an image of a picture unit undertaking the same role of a macroblock in the AVC scheme. The latter is fixed to a size of 16×16 pixels, but the former is not fixed to a certain size but designated in image compression information in each sequence.

For example, a largest coding unit (LCU) and a smallest coding unit (SCU) of a CU are specified in a sequence parameter set (SPS) included in encoded data to be output.

As split-flag=1 is set in a range in which each LCU is not smaller than an SCU, a coding unit can be divided into CUs having a smaller size. In the example of FIG. 1, a size of an LCU is 128, and a largest scalable depth is 5. A CU of a size of 2N×2N is divided into CUs having a size of N×N serving as a layer that is one-level lower when a value of split flag is 1.

Further, a CU is divided in prediction units (PUs) that are areas (partial areas of an image of a picture unit) serving as processing units of intra or inter prediction, and divided into transform units (TUs) that are areas (partial areas of an image of a picture unit) serving as processing units of orthogonal transform. Currently, in the HEVC scheme, in addition to 4×4 and 8×8, orthogonal transform of 16×16 and 32×32 can be used.

As in the HEVC scheme, in the case of an encoding scheme in which a CU is defined and various kinds of processes are performed in units of CUs, in the AVC scheme, a macroblock can be considered to correspond to an LCU, and a block (sub block) can be considered to correspond to a CU. Further, in the AVC scheme, a motion compensation block can be considered to correspond to a PU. Here, since a CU has a hierarchical structure, a size of an LCU of a topmost layer is commonly set to be larger than a macroblock in the AVC scheme, for example, such as 128×128 pixels.

Thus, hereinafter, an LCU is assumed to include a macroblock in the AVC scheme, and a CU is assumed to include a block (sub block) in the AVC scheme. In other words, a “block” used in the following description indicates an arbitrary partial area in a picture, and, for example, a size, a shape, and characteristics thereof are not limited. In other words, a “block” includes an arbitrary area (a processing unit) such as a TU, a PU, an SCU, a CU, an LCU, a sub block, a macroblock, or a slice. Of course, a “block” includes other partial areas (processing units) as well. When it is necessary to limit a size, a processing unit, or the like, it will be appropriately described.

In addition, in the present specification, a coding tree unit (CTU) is assumed to be a unit which includes a coding tree block (CTB) of an LCU (a CU having a largest value) and a parameter used when processing is performed with an LCU base (level) thereof. In addition, a coding unit (CU) constituting a CTU is assumed to be a unit which includes a coding block (CB) and a parameter used when processing is performed with a CU base (level) thereof.

### [Mode Selection]

Meanwhile, in the AVC and HEVC encoding schemes, in order to achieve high encoding efficiency, it is important to select an appropriate prediction mode.

As an example of such a selection method, there is a method implemented in reference software (found at http://iphome.hhi.de/suehring/tml/index.htm) of H.264/MPEG-4 AVC called a joint model (JM).

In the JM, as will be described later, it is possible to select two mode determination methods, that is, a high complexity mode and a low complexity mode. In both modes, cost function values related to respective prediction modes are calculated, and a prediction mode having a smaller cost function value is selected as an optimal mode for a corresponding block or macroblock.

A cost function in the high complexity mode is represented as in the following Formula (1):

Cost(ModeεΩ)=D+Aλ*R (1)

Here, Ω indicates a universal set of candidate modes for encoding a corresponding block or macroblock, and D indicates differential energy between a decoded image and an input image when encoding is performed in a corresponding prediction mode. λ indicates Lagrange's undetermined multiplier given as a function of a quantization parameter. R indicates a total coding amount including an orthogonal transform coefficient when encoding is performed in a corresponding mode.

In other words, in order to perform encoding in the high complexity mode, it is necessary to perform a temporary encoding process once by all candidate modes in order to calculate the parameters D and R, and thus a large computation amount is required.

A cost function in the low complexity mode is represented by the following Formula (2):

Cost(ModeεΩ)=D+QP2Quant(QP)*HeaderBit (2)

Here, D is different from that of the high complexity mode and indicates differential energy between a prediction image and an input image. QP2Quant (QP) is given as a function of a quantization parameter QP, and HeaderBit indicates a coding amount related to information belonging to a header such as a motion vector or a mode including no orthogonal transform coefficient.

In other words, in the low complexity mode, it is necessary to perform a prediction process for respective candidate modes, but since a decoded image is not necessary, it is unnecessary to perform an encoding process. Thus, it is possible to implement a computation amount smaller than that in the high complexity mode.

### [Scalable Video Coding]

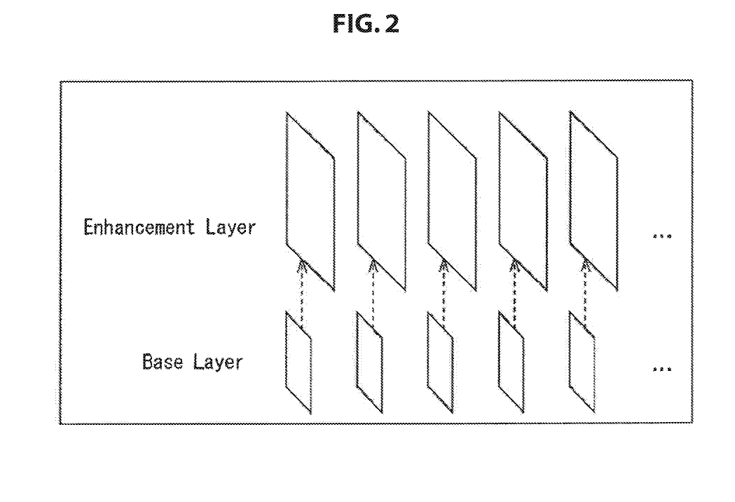

Meanwhile, the existing image encoding schemes such as MPEG2 and AVC have a scalability function as illustrated in FIGS. 2 to 4. Scalable video coding refers to a scheme of dividing (hierarchizing) an image into a plurality of layers and performing encoding for each layer.

In hierarchization of an image, one image is divided into a plurality of images (layers) based on a certain parameter. Basically, each layer is configured with differential data so that redundancy is reduced. For example, when one image is hierarchized into two layers, that is, a base layer and an enhancement layer, an image of a lower quality than an original image is obtained using only data of the base layer, and an original image (that is, a high-quality image) is obtained by combining data of the base layer with data of the enhancement layer.

As an image is hierarchized as described above, it is possible to obtain images of various qualities according to the situation. For example, for a terminal having a low processing capability such as a mobile phone, image compression information of only a base layer is transmitted, and a moving image of low spatial and temporal resolutions or a low quality is reproduced, and for a terminal having a high processing capability such as a television or a personal computer, image compression information of an enhancement layer as well as a base layer is transmitted, and a moving image of high spatial and temporal resolutions or a high quality is reproduced. In other words, image compression information according to a capability of a terminal or a network can be transmitted from a server without performing the transcoding process.

As a parameter having scalability, for example, there is spatial resolution (spatial scalability) as illustrated in FIG. 2. When the spatial scalability differs, respective layers have different resolutions. In other words, each picture is hierarchized into two layers, that is, a base layer of a resolution spatially lower than that of an original image and an enhancement layer that is combined with an image of the base layer to obtain an original image (an original spatial resolution) as illustrated in FIG. 2. Of course, the number of layers is an example, and each picture can be hierarchized into an arbitrary number of layers.

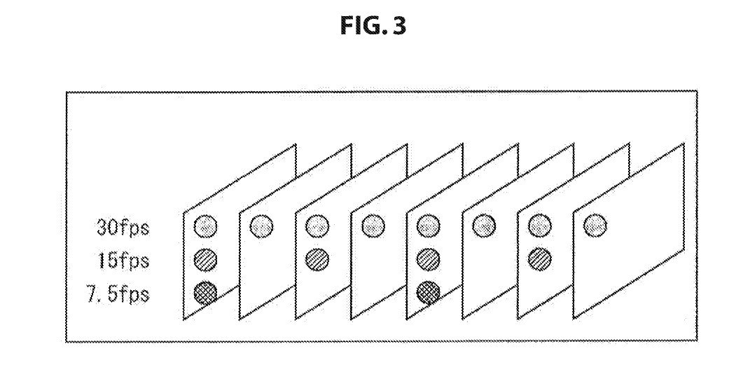

As another parameter having such scalability, for example, there is a temporal resolution (temporal scalability) as illustrated in FIG. 3. In the case of the temporal scalability, respective layers have different frame rates. In other words, in this case, each picture is hierarchized into layers having different frame rates, a moving image of a high frame rate can be obtained by combining a layer of a high frame rate with a layer of a low frame rate, and an original moving image (an original frame rate) can be obtained by combining all the layers as illustrated in FIG. 3. The number of layers is an example, and each picture can be hierarchized into an arbitrary number of layers.

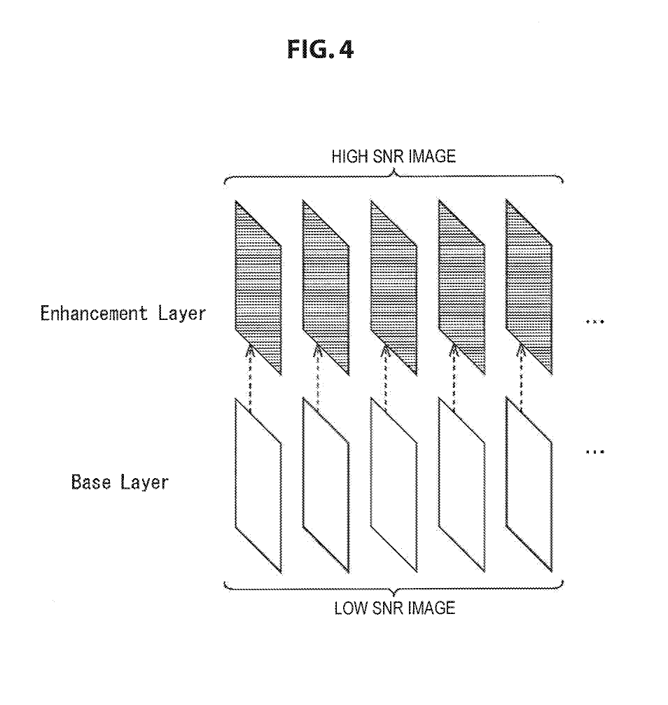

Further, as another parameter having such scalability, for example, there is a signal-to-noise ratio (SNR) (SNR scalability). In the case of the SNR scalability, respective layers having different SNRs. In other words, in this case, each picture is hierarchized into two layers, that is, a base layer of an SNR lower than that of an original image and an enhancement layer that is combined with an image of the base layer to obtain an original SNR as illustrated in FIG. 4. In other words, for base layer image compression information, information related to an image of a low PSNR is transmitted, and a high SNR image can be reconstructed by combining the information with the enhancement layer image compression information. Of course, the number of layers is an example, and each picture can be hierarchized into an arbitrary number of layers.

A parameter other than the above-described examples may be applied as a parameter having scalability. For example, there is bit-depth scalability in which the base layer includes an 8-bit image, and a 10-bit image can be obtained by adding the enhancement layer to the base layer.

Further, there is chroma scalability in which the base layer includes a component image of a 4:2:0 format, and a component image of a 4:2:2 format can be obtained by adding the enhancement layer to the base layer.

Further, as a parameter having scalability, there is a multi-view. In this case, an image is hierarchized into layers of different views.

For example, layers described in the present embodiment include spatial, temporal, SNR, bit depth, color, and view of scalability video coding described above.

Further, a term “layer” used in this specification includes a layer of scalable video coding and each view when a multi-view of a multi-view is considered.

Further, the term “layer” used in this specification is assumed to include a main layer (corresponding to sub) and a sublayer. As a specific example, a main layer may be a layer of spatial scalability, and a sublayer may be configured with a layer of temporal scalability.

In the present embodiment, a layer (Japanese) and a layer have the same meaning, a layer (Japanese) will be appropriately described as a layer.

### [Intra Prediction]

An intra prediction scheme defined in HEVC will be described.

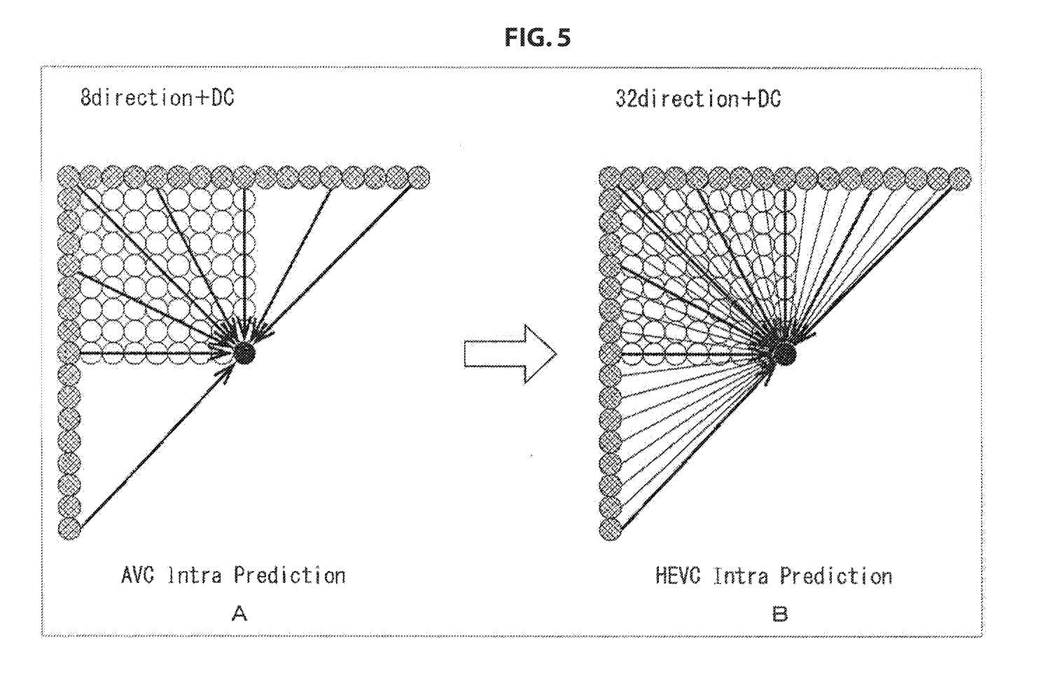

While intra 4×4 prediction, intra 8×8 prediction, and intra 16×16 prediction are present in AVC, angular prediction as illustrated in FIG. 5 is applied to 4×4 to 64×64 pixel blocks in HEVC.

That is to say, in AVC, intra prediction is performed through 8 directions+direct current (DC) as illustrated in A of FIG. 5. On the other hand, in HEVC, intra prediction is performed through 32 directions+direct current (DC) as illustrated in B of FIG. 5. Accordingly, prediction accuracy is improved in HEVC.

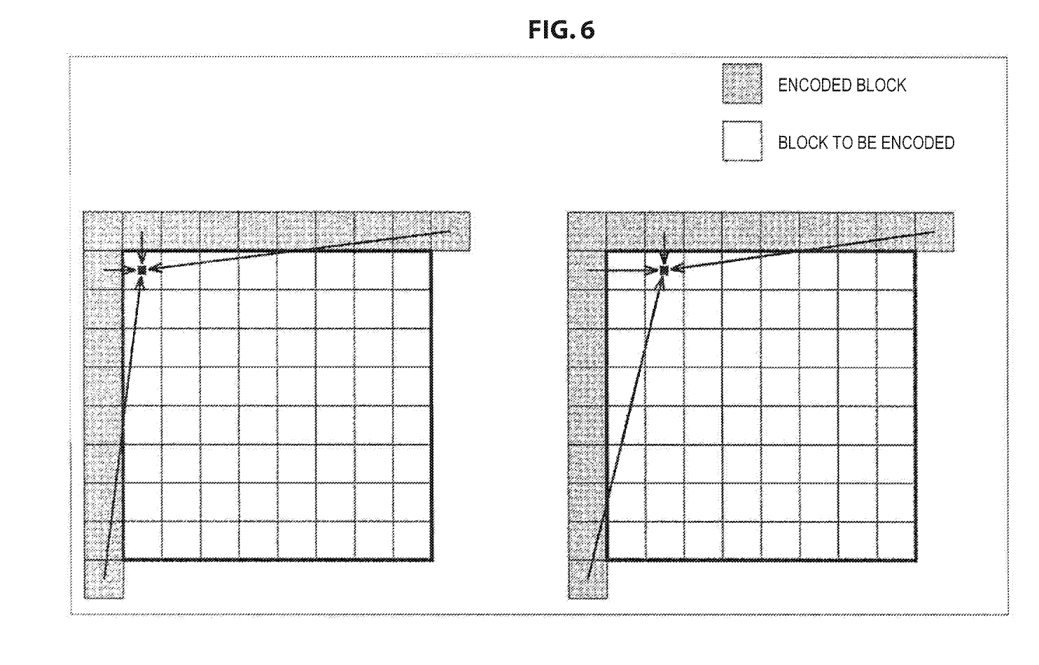

In addition, planar prediction as illustrated in FIG. 6 is defined in HEVC. That is to say, in a planar prediction process, a prediction pixel included in an encoding block is generated through bi-linear interpolation from adjacent pixels that have already been encoded. Planar prediction improves encoding efficiency of a region that is likely to have gradation.

### [Encoding Scheme of an Intra Prediction Mode]

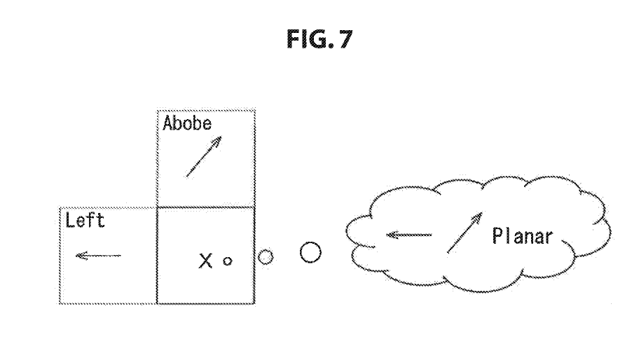

Next, an encoding scheme of an intra prediction mode in HEVC will be described. In HEVC, an encoding process of an intra prediction mode using three most probable modes is performed as illustrated in FIG. 7.

That is to say, three candidate intra prediction modes are generated from the abobe and left side in this scheme. The third candidate mode is decided with a combination of the first (intra prediction mode of the abobe) and the second (intra prediction mode of the left). In addition, when the abobe and the left are the same mode, different modes are set as candidates, and thereby encoding efficiency is improved.

When a prediction mode and any of the most probable modes of a corresponding block are the same, the index number thereof is transmitted into image compression information which will serve as an output. When a prediction mode and any of the most probable modes of the corresponding block are not the same, mode information of the prediction block is transmitted with a fixed length of 5 bits.

### [In-Screen Motion Search of Intra Prediction]

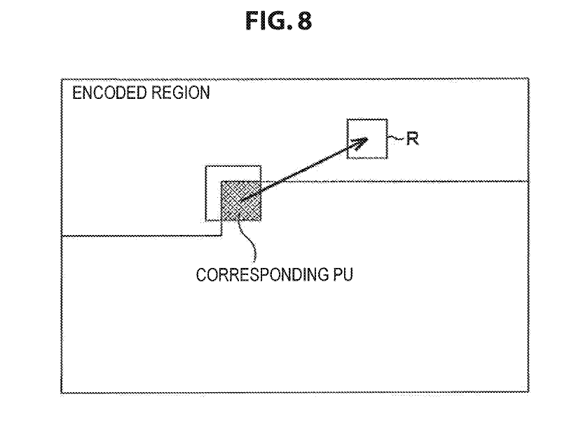

Non-Patent Literature 1 proposes, when a region R having a high correlation with a corresponding PU is present in a region that has already been encoded within the same picture as illustrated in FIG. 8, referring to the region R, and accordingly, encoding efficiency is improved.

However, searching for such a region while performing an encoding process or a decoding process as proposed in Non-Patent Literature 1 brings about an increase in a computation amount.

It can be said that the same applies when an enhancement layer image encoding process and decoding process are performed when a scalable video coding process is performed.

Thus, in the present technology, an in-screen motion search is performed on a region of an image of a base layer which corresponds to a region that has already been encoded in an enhancement layer. Then, a pixel included in a current block of the enhancement layer is used as a predictive image for the current block using the in-screen motion information that has been searched for.

### [Operation Principle of the Present Technology]

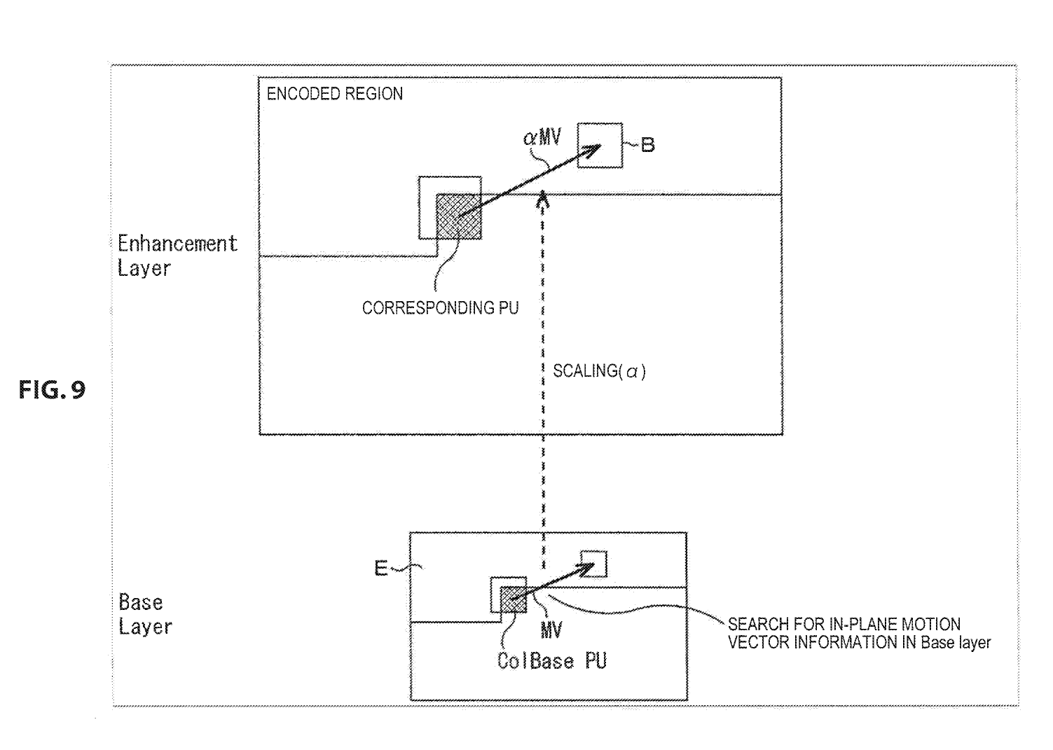

The operation principle of the present technology will be described with reference to FIG. 9.

In the example of FIG. 9, a picture in the enhancement layer and a picture in the base layer are illustrated.

The corresponding PU (current block) is shown in the picture of the enhancement layer, and the region just before the corresponding PU in a raster scanning order is an encoded region in the picture of the enhancement layer.

In the picture of the base layer, a PU at a collocated position with the corresponding PU (hereinafter also referred to as a ColBase PU) is shown. Thus, in the picture of the base layer, the region just before the ColBase PU in the raster scanning order is the region corresponding to the encoded region of the enhancement layer.

Here, as a first step, the ColBase PU at the collocated position with the corresponding PU of the enhancement layer is detected in the base layer.

As a second step, an in-screen motion search is performed on the ColBase PU using, for example, a method such as block matching in the region E of a base layer decoded image corresponding to the encoded region of the enhancement layer. It should be noted that, as a motion search, a search for decimal pixel accuracy may be performed as stipulated in HEVC. In this case, the same interpolation filter as stipulated in HEVC is used.

In addition, in this case, a search range may be transmitted in syntax elements such as a sequence parameter set (SPS), a picture parameter set (PPS), and a slice header of enhancement layer image compression information along with layer image encoded data obtained by encoding image data constituted with a plurality of layers.

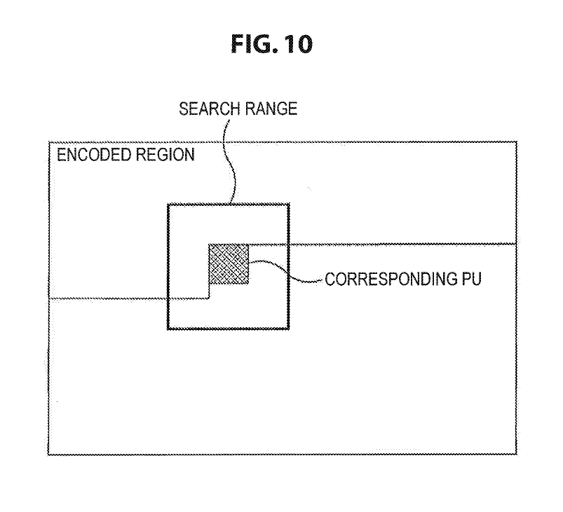

FIG. 10 is a diagram illustrating an example in which the search range is limited. That is to say, the range of ±δ is designated for the corresponding PU in the enhancement layer image compression information. It should be noted that the subject for the actual search is a region that has already been encoded out of the designated range.

Returning to FIG. 9, as a third step, when encoding is performed with special scalability, scaling (a) in which in-screen motion vector information MV that has been searched for in the second step is set as enhancement layer resolution is performed.

As a fourth step, using the in-screen motion vector information αMV obtained in the third step, pixels included in the block B corresponding to the corresponding PU of the enhancement layer are used as a predictive image for the corresponding PU.

It should be noted that, in the prediction method according to the present technology described above, selection based on a mode determination process is performed using a cost function in the encoding side as one prediction mode (for example, a prediction mode of the in-screen motion search) of the candidate intra prediction modes of the enhancement layer.

Since a process of the base layer has been completed when an encoding process of the enhancement layer is performed, the in-screen motion search process for the base layer described above can be performed in parallel with the encoding process of the enhancement layer.

In addition, in scalable video coding, since the base layer and the enhancement layer have a high correlation in texture information, a high correlation with the enhancement layer can be detected in the in-screen motion search process of the base layer described above.

It should be noted that, as the above-described process is performed on both encoding and decoding sides, it is not necessary to transmit in-screen motion vector information to the image compression information, and thus higher encoding efficiency can be realized.

Alternatively, the in-screen motion vector information that has been searched for on the encoding side may be transmitted in image compression information which will serve as an output. In this case, an in-screen motion search on the decoding side is not necessary.

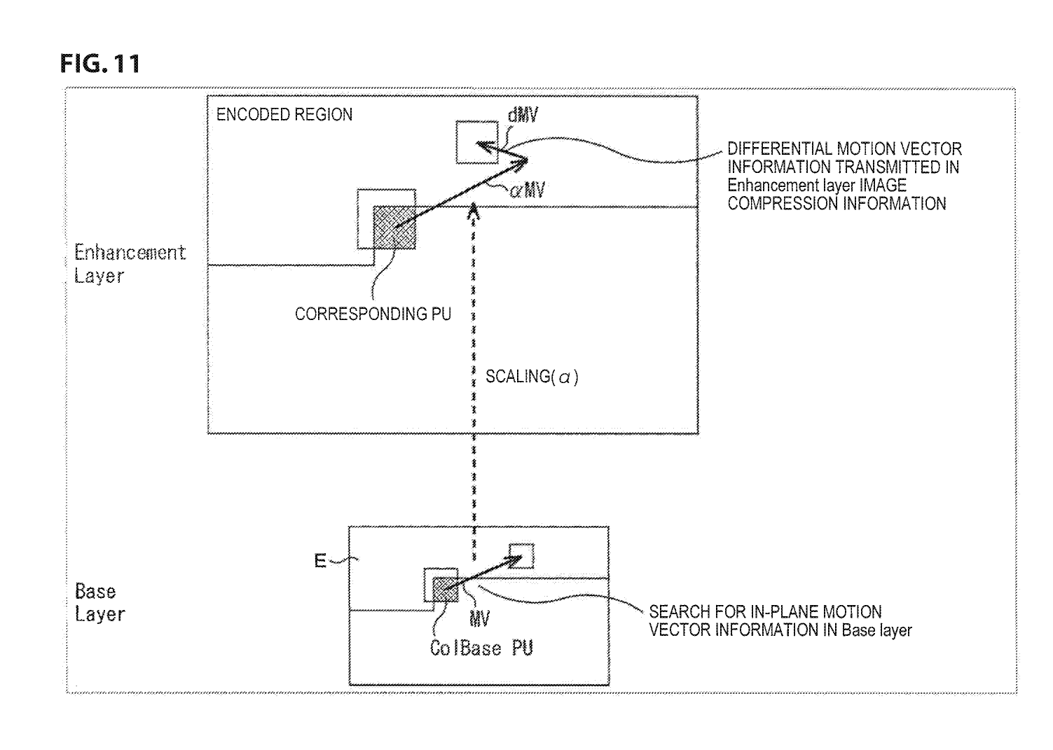

In addition, as illustrated in FIG. 11, the in-screen motion vector information MV is computed using the base layer decoded image. Then, using the in-screen motion vector information αMV obtained by scaling the computed in-screen motion vector information MV, an in-screen motion search is performed in the periphery of the block corresponding to the in-screen motion vector information αMV of the enhancement layer again, and thereby in-screen motion vector information to be used in an enhancement layer decoding process having higher accuracy can be obtained.

In this case, differential in-screen motion vector information dMV between the in-screen motion vector information αMV and the in-screen motion vector information used in the enhancement layer decoding process may be transmitted in the image compression information which will serve as an output.

At this time, on the decoding side, the in-screen motion vector information MV is computed using the base layer decoded image, by summating the in-screen motion vector information αMV obtained by scaling the information and the differential in-screen motion vector information dMV from the encoding side, in-screen motion vector information to be used in the enhancement layer decoding process is computed, and thereby a predictive image is generated.

It should be noted that the present technology is not limited to the example of FIG. 9 or FIG. 1I, and in-screen motion search may be performed in an up-sampled base layer. In this case, a scaling process of the in-screen motion vector information described above is not necessary.

In addition, the present technology can be applied to both luminance signals and color difference signals. The luminance signals and color difference signals may be processed separately from each other, and with respect to color difference signals, Cb/Cr components may be processed separately. Alternatively, motion information detected in a luminance signal may be applied to a color difference signal. In addition, motion information detected in a Cb signal may be applied to a Cr signal.

Next, an application example of the present technology described above to a specific device will be described.

### 1. First Embodiment

### [Scalable Encoding Device]

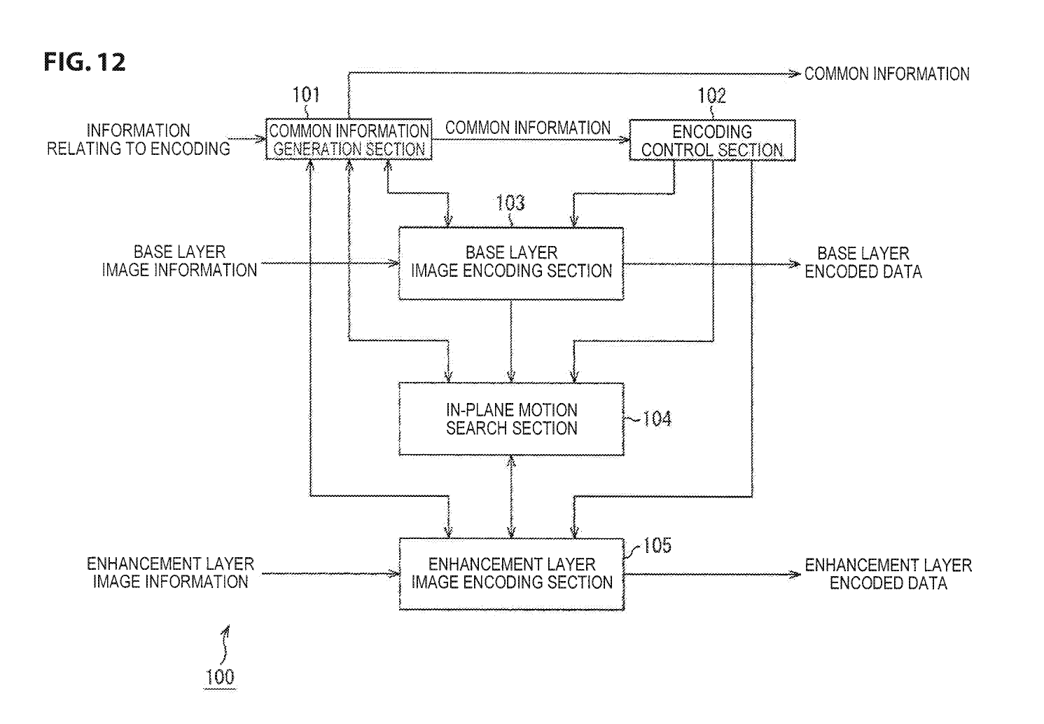

FIG. 12 is a block diagram illustrating an example of a main configuration of a scalable encoding device. It should be noted that motion vector information will be also be appropriately referred to hereinbelow as motion information.

The scalable encoding device 100 illustrated in FIG. 12 is an image information processing device which performs scalable encoding on image data, and encodes each layer of image data divided into layers including a base layer and an enhancement layer. A parameter used as a criterion of dividing into layers (a parameter that brings scalability) is arbitrary. The scalable encoding device 100 has a common information generation section 101, an encoding control section 102, a base layer image encoding section 103, an in-screen motion search section 104, and an enhancement layer image encoding section 105.

The common information generation section 101 acquires information related to encoding of image data that is likely to be stored in, for example, an NAL unit. In addition, the common information generation section 101 acquires necessary information from the base layer image encoding section 103, the in-screen motion search section 104, and the enhancement layer image encoding section 105 as necessary. The common information generation section 101 generates common information that is information relating to all layers based on the aforementioned information. The common information includes, for example, a video parameter set and the like. The common information generation section 101 outputs the generated common information to the outside of the scalable encoding device 100 as, for example, an NAL unit. It should be noted that the common information generation section 101 also supplies the generated common information to the encoding control section 102. Furthermore, the common information generation section 101 also supplies some or all of the generated common information to the base layer image encoding section 103 to the enhancement layer image encoding section 105 as necessary.

The encoding control section 102 controls encoding of each layer by controlling the base layer image encoding section 103 to the enhancement layer image encoding section 105 based on the common information supplied from the common information generation section 101.

The base layer image encoding section 103 acquires image information of the base layer (base layer image information). The base layer image encoding section 103 encodes the base layer image information without using information of another layer, and generates and outputs encoded data of the base layer (base layer encoded data). In addition, the base layer image encoding section 103 supplies base layer decoded image information obtained at the time of encoding to the in-screen motion search section 104.

The in-screen motion search section 104 receives supply of the address of a current block (corresponding PU) of the enhancement layer, and supply of the base layer decoded image information from the base layer image encoding section 103.

The in-screen motion search section 104 detects a ColBase block (ColBase PU) corresponding to the current block (corresponding PU) of the enhancement layer from the base layer decoded image information supplied from the base layer image encoding section 103, performs an in-screen search on the ColBase block, and supplies in-screen motion information obtained as a result of the search to the enhancement layer image encoding section 105.

The enhancement layer image encoding section 105 acquires image information of the enhancement layer (enhancement layer image information). The enhancement layer image encoding section 105 encodes the enhancement layer image information. At this time, the enhancement layer image encoding section 105 encodes the enhancement layer image information using not only information of the enhancement layer but also information of the base layer up-sampled by the in-screen motion search section 104, if necessary.

In addition, when one intra prediction mode is performed, the enhancement layer image encoding section 105 supplies address information of a current block to the in-screen motion search section 104 in order to obtain in-screen motion information that is the result of an in-screen search performed on the ColBase block of the current block in the base layer decoded image information. The enhancement layer image encoding section 105 performs an in-screen search on the ColBase block and acquires in-screen motion information obtained from the result from the in-screen motion search section 104. The enhancement layer image encoding section 105 generates a predictive image of the current block using the acquired in-screen motion information. Through the encoding, the enhancement layer image encoding section 105 generates and outputs encoded data of the enhancement layer (enhancement layer encoded data).

### [Base Layer Image Encoding Section]

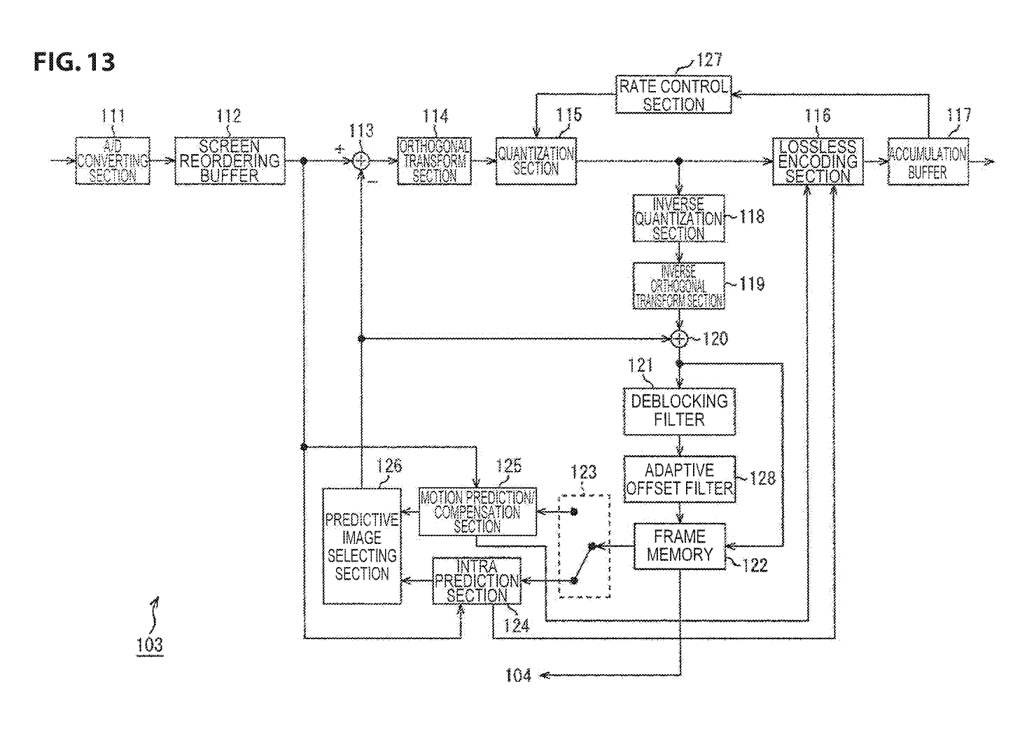

FIG. 13 is a block diagram illustrating an example of a main configuration of the base layer image encoding section 103 of FIG. 12. As illustrated in FIG. 13, the base layer image encoding section 103 has an A/D converting section 111, a screen reordering buffer 112, an operation section 113, an orthogonal transform section 114, a quantization section 115, a lossless encoding section 116, an accumulation buffer 117, an inverse quantization section 118, and an inverse orthogonal transform section 119. In addition, the base layer image encoding section 103 has an operation section 120, a deblocking filter 121, a frame memory 122, a selecting section 123, an intra prediction section 124, a motion prediction/compensation section 125, a predictive image selecting section 126, and a rate control section 127. Further, the base layer image encoding section 103 has an adaptive offset filter 128 between the deblocking filter 121 and the frame memory 122.

The A/D converting section 111 performs A/D conversion on input image data (the base layer image information), and supplies the converted image data (digital data) to be stored in the screen reordering buffer 112. The screen reordering buffer 112 reorders images of frames stored in a display order in a frame order for encoding according to a Group Of Pictures (GOP), and supplies the images in which the frame order is reordered to the operation section 113. The screen reordering buffer 112 also supplies the images in which the frame order is reordered to the intra prediction section 124 and the motion prediction/compensation section 125.

The operation section 113 subtracts a predictive image supplied from the intra prediction section 124 or the motion prediction/compensation section 125 via the predictive image selecting section 126 from an image read from the screen reordering buffer 112, and outputs differential information thereof to the orthogonal transform section 114. For example, in the case of an image that has been subjected to intra coding, the operation section 113 subtracts the predictive image supplied from the intra prediction section 124 from the image read from the screen reordering buffer 112. Further, for example, in the case of an image that has been subjected to inter coding, the operation section 113 subtracts the predictive image supplied from the motion prediction/compensation section 125 from the image read from the screen reordering buffer 112.

The orthogonal transform section 114 performs an orthogonal transform such as a discrete cosine transform or a Karhunen-Loeve Transform on the differential information supplied from the operation section 113. The orthogonal transform section 114 supplies transform coefficients to the quantization section 115.

The quantization section 115 quantizes the transform coefficients supplied from the orthogonal transform section 114. The quantization section 115 sets a quantization parameter based on information related to a target value of a coding amount supplied from the rate control section 127, and performs the quantizing. The quantization section 115 supplies the quantized transform coefficients to the lossless encoding section 116.

The lossless encoding section 116 encodes the transform coefficients quantized in the quantization section 115 according to an arbitrary encoding scheme. Since coefficient data is quantized under control of the rate control section 127, the coding amount becomes a target value (or approaches a target value) set by the rate control section 127.

The lossless encoding section 116 acquires information indicating an intra prediction mode or the like from the intra prediction section 124, and acquires information indicating an inter prediction mode, differential motion vector information, or the like from the motion prediction/compensation section 125. Further, the lossless encoding section 116 appropriately generates an NAL unit of the base layer including a sequence parameter set (SPS), a picture parameter set (PPS), and the like.

The lossless encoding section 116 acquires information indicating an intra prediction mode or the like from the intra prediction section 124, and acquires information indicating an inter prediction mode, differential motion vector information, or the like from the motion prediction/compensation section 125. Further, the lossless encoding section 116 appropriately generates an NAL unit of the enhancement layer including a sequence parameter set (SPS), a picture parameter set (PPS), and the like.

Examples of the encoding scheme of the lossless encoding section 116 include variable length coding and arithmetic coding. As the variable length coding, for example, there is Context-Adaptive Variable Length Coding (CAVLC) defined in the H.264/AVC scheme. As the arithmetic coding, for example, there is Context-Adaptive Binary Arithmetic Coding (CABAC).

The accumulation buffer 117 temporarily holds the encoded data (base layer encoded data) supplied from the lossless encoding section 116. The accumulation buffer 117 outputs the held base layer encoded data to a recording device (recording medium), a transmission path, or the like (not illustrated) at a subsequent stage at a certain timing. In other words, the accumulation buffer 117 serves as a transmitting section that transmits the encoded data as well.

The transform coefficients quantized by the quantization section 115 are also supplied to the inverse quantization section 118. The inverse quantization section 118 inversely quantizes the quantized transform coefficients according to a method corresponding to the quantization performed by the quantization section 115. The inverse quantization section 118 supplies the obtained transform coefficients to the inverse orthogonal transform section 119.

The inverse orthogonal transform section 119 performs an inverse orthogonal transform on the transform coefficients supplied from the inverse quantization section 118 according to a method corresponding to the orthogonal transform process performed by the orthogonal transform section 114. An output (restored differential information) that has been subjected to the inverse orthogonal transform is supplied to the operation section 120.

The operation section 120 obtains a locally decoded image (a decoded image) by adding the predictive image supplied from the intra prediction section 124 or the motion prediction/compensation section 125 via the predictive image selecting section 126 to the restored differential information serving as an inverse orthogonal transform result supplied from the inverse orthogonal transform section 119. The decoded image is supplied to the deblocking filter 121 or the frame memory 122.

The deblocking filter 121 removes block distortion of a reconstructed image by performing a deblocking filtering process on the reconstructed image supplied from the operation section 120. The deblocking filter 121 supplies the image that has undergone the filtering process to the adaptive offset filter 128.

The adaptive offset filter 128 performs an adaptive offset filtering (sample adaptive offset or SAO) process for mainly removing ringing on the deblocking filtering process result (the reconstructed image of which block distortion has been removed) from the deblocking filter 121.

In more detail, the adaptive offset filter 128 decides a type of adaptive offset filtering process for each largest coding unit (LCU) that is the largest encoding unit, and obtains an offset used in the adaptive offset filtering process. Using the obtained offset, the adaptive offset filter 128 performs the adaptive offset filtering process of the decided type for the image after the adaptive deblocking filtering process. Then, the adaptive offset filter 128 supplies the image after the adaptive offset filtering process (hereinafter referred to as a decoded image) to the frame memory 122.

It should be noted that the deblocking filter 121 and the adaptive offset filter 128 can supply information such as a filter coefficient used in the filtering process to the lossless encoding section 116 to encode the information as necessary. In addition, an adaptive loop filter may be provided in the latter stage of the adaptive offset filter 128.

The frame memory 122 stores the reconstructed image supplied from the operation section 120 and the decoded image supplied from the adaptive offset filter 128. The frame memory 122 supplies the stored reconstructed image to the intra prediction section 124 via the selecting section 123 at a certain timing or based on an external request, for example, from the intra prediction section 124. Further, the frame memory 122 supplies the stored decoded image to the motion prediction/compensation section 125 via the selecting section 123 at a certain timing or based on an external request, for example, from the motion prediction/compensation section 125.

The frame memory 122 stores the supplied decoded image, and supplies the stored decoded image to the selecting section 123 as a reference image at a certain timing. In addition, the frame memory 122 supplies the decoded image to the in-screen motion search section 104 as base layer decoded image information.

The selecting section 123 selects a supply destination of the reference image supplied from the frame memory 122. For example, in the case of the intra prediction, the selecting section 123 supplies the reference image (a pixel value of a current picture) supplied from the frame memory 122 to the motion prediction/compensation section 125. Further, for example, in the case of the inter prediction, the selecting section 123 supplies the reference image supplied from the frame memory 122 to the motion prediction/compensation section 125.

The intra prediction section 124 performs the intra prediction (intra-screen prediction) for generating the predictive image using the pixel value of the current picture serving as the reference image supplied from the frame memory 122 via the selecting section 123. The intra prediction section 124 performs the intra prediction in a plurality of intra prediction modes that are prepared in advance.

The intra prediction section 124 generates predictive images in all the intra prediction modes serving as the candidates, evaluates cost function values of the predictive images using the input image supplied from the screen reordering buffer 112, and selects an optimal mode. When the optimal intra prediction mode is selected, the intra prediction section 124 supplies the predictive image generated in the optimal mode to the predictive image selecting section 126.

As described above, the intra prediction section 124 appropriately supplies, for example, the intra prediction mode information indicating the employed intra prediction mode to the lossless encoding section 116 so that the information is encoded.

The motion prediction/compensation section 125 performs the motion prediction (the inter prediction) using the input image supplied from the screen reordering buffer 112 and the reference image supplied from the frame memory 122 via the selecting section 123. The motion prediction/compensation section 125 performs a motion compensation process according to a detected motion vector, and generates a predictive image (inter-predictive image information). The motion prediction/compensation section 125 performs the inter prediction in a plurality of inter prediction modes that are prepared in advance.

The motion prediction/compensation section 125 generates predictive images in all the inter prediction modes serving as a candidate. The motion prediction/compensation section 125 evaluates cost function values of the predictive images using the input image supplied from the screen reordering buffer 112, information of the generated differential motion vector, and the like, and selects an optimal mode. When the optimal inter prediction mode is selected, the motion prediction/compensation section 125 supplies the predictive image generated in the optimal mode to the predictive image selecting section 126.

The motion prediction/compensation section 125 supplies information indicating the employed inter prediction mode, information necessary for performing processing in the inter prediction mode when the encoded data is decoded, and the like to the lossless encoding section 116 so that the information is encoded. For example, as the necessary information, there is information of a generated differential motion vector, and as prediction motion vector information, there is a flag indicating an index of a prediction motion vector.

The predictive image selecting section 126 selects a supply source of the prediction image to be supplied to the operation section 113 and the operation section 120. For example, in the case of the intra coding, the predictive image selecting section 126 selects the intra prediction section 124 as the supply source of the predictive image, and supplies the predictive image supplied from the intra prediction section 124 to the operation section 113 and the operation section 120. For example, in the case of the inter coding, the predictive image selecting section 126 selects the motion prediction/compensation section 125 as the supply source of the predictive image, and supplies the predictive image supplied from the motion prediction/compensation section 125 to the operation section 113 and the operation section 120.

The rate control section 127 controls a rate of a quantization operation of the quantization section 115 based on the coding amount of the encoded data accumulated in the accumulation buffer 117 such that no overflow or underflow occurs.

### [Enhancement Layer Image Encoding Section]

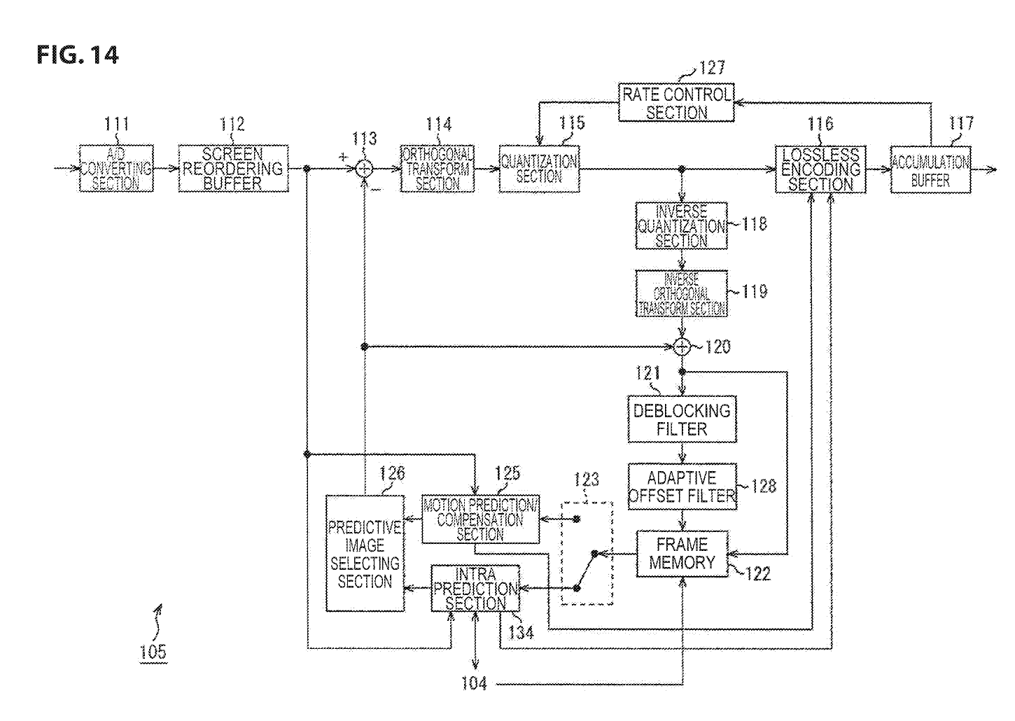

FIG. 14 is a block diagram illustrating an example of a main configuration of the enhancement layer image encoding section 105 of FIG. 12. As illustrated in FIG. 14, the enhancement layer image encoding section 105 basically has the same configuration as the base layer image encoding section 103 of FIG. 12.

However, each section of the enhancement layer image encoding section 105 performs processing relating to encoding of enhancement layer image information, rather than of the base layer. That is to say, the A/D converting section Ill of the enhancement layer image encoding section 105 performs A/D conversion on the enhancement layer image information, and the accumulation buffer 117 of the enhancement layer image encoding section 105 outputs the enhancement layer encoded data to, for example, a recording device (recording medium) or a transmission path in the latter stage, which is not illustrated.

In addition, the enhancement layer image encoding section 105 has an intra prediction section 134 instead of the intra prediction section 124.

The intra prediction section 134 performs intra prediction (in-screen prediction) for generating a predictive image using a pixel value within a current picture that is a reference image supplied from the frame memory 122 via the selecting section 123. While this intra prediction is performed in a plurality of intra prediction modes prepared by the intra prediction section 124 in advance, the intra prediction section 134 also performs intra prediction in the in-screen motion search prediction mode of the present technology described above, in addition to the plurality of intra prediction modes prepared in advance.

That is to say, in order to obtain in-screen motion information that is the result of in-screen search on a ColBase block (a collocated block of the base layer) of the current block of the enhancement layer, the intra prediction section 134 supplies address information of the current block to the in-screen motion search section 104. Then, the intra prediction section 134 performs in-screen search on the ColBase block with the in-screen motion search section 104 to acquire in-screen motion information obtained as a result of the search, and generates predictive images of the current block using the acquired in-screen motion information.

The intra prediction section 134 generates predictive images in all the intra prediction modes serving as the candidates, evaluates cost function values of the predictive images using the input image supplied from the screen reordering buffer 112, and selects an optimal mode. When the optimal intra prediction mode is selected, the intra prediction section 134 supplies the predictive image generated in the optimal mode to the predictive image selecting section 126.

In addition, as described above, the intra prediction section 134 appropriately supplies intra prediction mode information and the like indicating the employed intra prediction mode to the lossless encoding section 116 to cause the information to be encoded. It should be noted that, when the above-described search range, in-screen motion information, differential in-screen motion information, or the like is transmitted to the decoding side, the information is appropriately supplied to the lossless encoding section 116 to cause the information to be encoded.

It should be noted that the frame memory 122 also receives an input of up-sampled base layer decoded image information from the in-screen motion search section 104 to cause the information to be used in the intra prediction section 134 or the motion prediction/compensation section 125 to be used as a reference image.

### [Intra Prediction Section and In-Screen Motion Search Section]

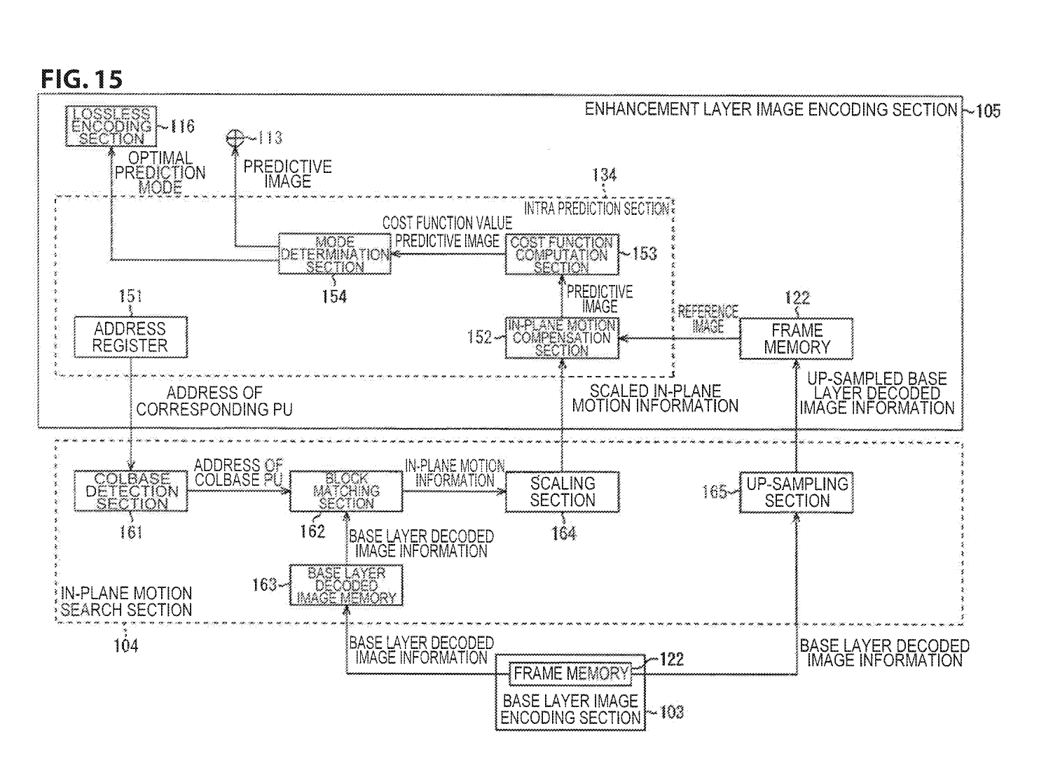

FIG. 15 is a block diagram illustrating an example of a main configuration of the intra prediction section 134 of FIG. 14 and the in-screen motion search section 104 of FIG. 12. It should be noted that, as a prediction processing unit block, PU will be exemplified hereinbelow.

As illustrated in FIG. 15, the intra prediction section 134 has an address register 151, an in-screen motion compensation section 152, a cost function computation section 153, and a mode determination section 154.

The in-screen motion search section 104 has a ColBase detection section 161, a block matching section 162, a base layer decoded image memory 163, a scaling section 164, and an up-sampling section 165.

The address register 151 supplies information relating to the address of a corresponding PU that is a current block of the enhancement layer to the ColBase detection section 161.

The in-screen motion compensation section 152 receives supply of in-screen motion information scaled by the scaling section 164, and supply of a reference image from the frame memory 122. The in-screen motion compensation section 152 generates predictive images in the prediction modes of in-screen motion search according to the present technology. That is to say, the in-screen motion compensation section 152 extracts the predictive images by referring to the reference image from the frame memory 122 and using the scaled in-screen motion information, and supplies the extracted predictive images to the cost function computation section 153.

In addition, the in-screen motion compensation section 152 generates predictive images in other intra prediction modes of HEVC by referring to the reference image from the frame memory 122, and supplies the generated predictive images to the cost function computation section 153.

The cost function computation section 153 performs computation of a cost function value relating to the prediction modes according to the present technology and other intra prediction modes, and supplies the computed cost function value to the mode determination section 154 together with the predictive images of the respective modes.

The mode determination section 154 decides a prediction mode in which the cost function value computed by the cost function computation section 153 becomes the minimum as the optimal prediction mode, supplies information relating to the decided optimal prediction mode to the lossless encoding section 116, and supplies the predictive images to the operation section 113.

Using the address of the corresponding PU supplied from the address register 151, the ColBase detection section 161 computes the address of the collocated block (ColBase PU) corresponding to the address of the corresponding PU of the enhancement layer in the base layer. The ColBase detection section 161 supplies the computed address of the ColBase PU to the block matching section 162.

Using the address of the ColBase PU supplied from the ColBase detection section 161, the block matching section 162 performs, for example, in-screen search of block matching relating to the ColBase PU from the base layer decoded image information accumulated in the base layer decoded image memory 163. The block matching section 162 supplies the in-screen motion information that is the result of the in-screen motion search to the scaling section 164.

The base layer decoded image information is supplied from the frame memory 122 of the base layer image encoding section 103 to the base layer decoded image memory 163 and the up-sampling section 165.

The base layer decoded image memory 163 accumulates the base layer decoded image information from the frame memory 122 of the base layer image encoding section 103. The base layer decoded image memory 163 supplies the accumulated base layer decoded image information to the block matching section 162.

The scaling section 164 scales the in-screen motion information supplied from the block matching section 162 to the resolution of the enhancement layer, and supplies the scaled in-screen motion information to the in-screen motion compensation section 152.

The up-sampling section 165 performs an up-sampling process on the base layer decoded image information supplied from the frame memory 122 of the base layer image encoding section 103 to the resolution of the enhancement layer. The up-sampling section 165 supplies the up-sampled base layer decoded image information to the frame memory 122 of the enhancement layer image encoding section 105.

As described above, the scalable encoding device 100 performs in-screen motion search on the corresponding block of the base layer corresponding to the current block of the enhancement layer as one intra prediction of the enhancement layer. Then, the scalable encoding device 100 generates a predictive image of the current block of the enhancement layer using in-screen motion information that is the result of the search.

Since processing of the base layer has already been completed when the encoding process of the enhancement layer is performed, the in-screen motion search process of the base layer described above can be performed in parallel with the performance of the encoding process of the enhancement layer.

In addition, since the base layer and the enhancement layer have a high correlation in texture information in scalable encoding, the in-screen motion search process of the base layer described above can be detected to have a high correlation with that of the enhancement layer.

Accordingly, encoding efficiency of the enhancement layer can be improved.

### [Flow of an Encoding Process]

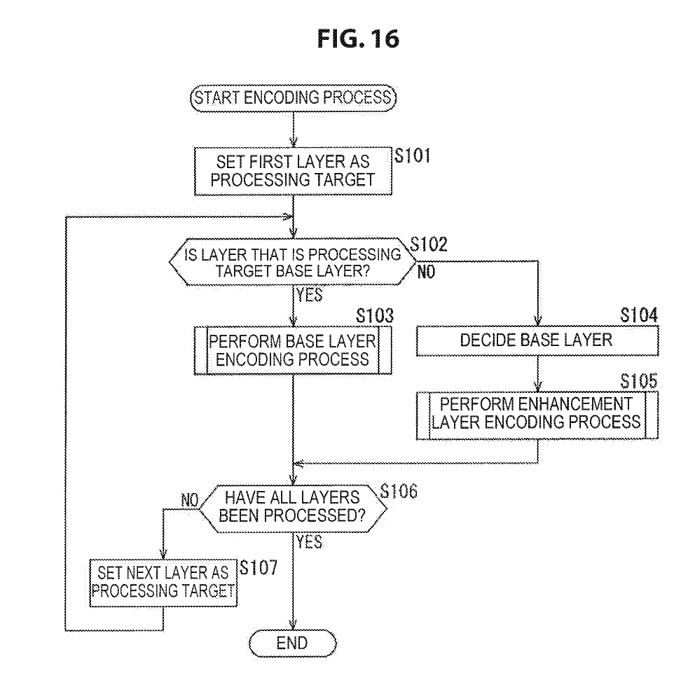

Next, the flow of respective processes executed by the scalable encoding device 100 as described above will be described. First, an example of the flow of an encoding process will be described with reference to the flowchart of FIG. 16. The scalable encoding device 100 executes the encoding process for each picture.

When the encoding process is started, the encoding control section 102 of the scalable encoding device 100 sets the first layer as a processing target in Step S101.

In Step S102, the encoding control section 102 determines whether or not the current layer that is the processing target is a base layer. When the current layer is determined to be a base layer, the process proceeds to Step S103.

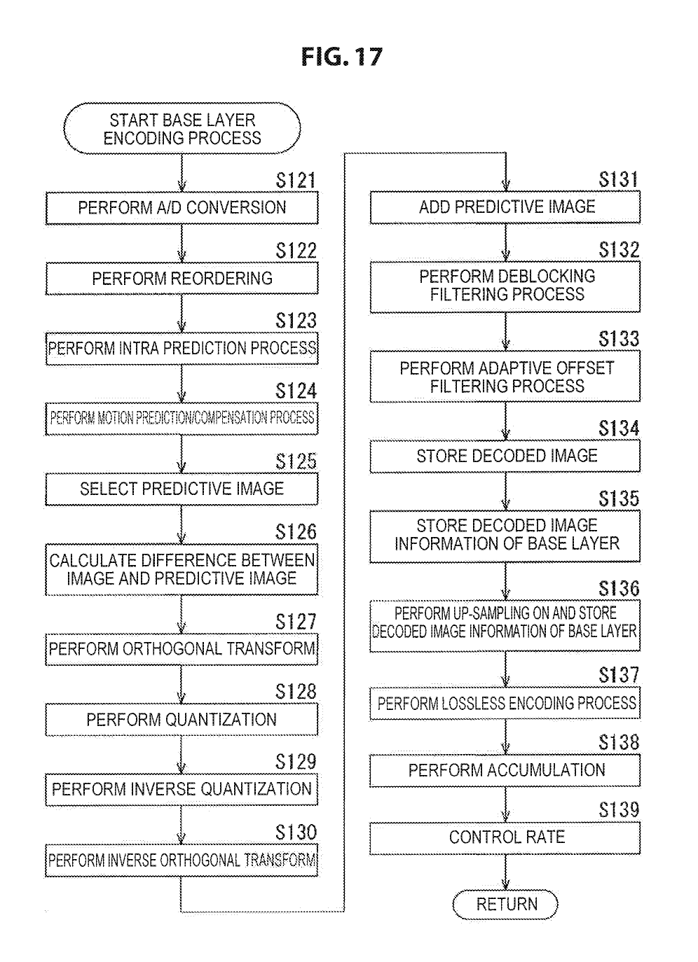

In Step S103, the base layer image encoding section 103 performs a base layer encoding process. Details of the base layer encoding process will be described below with reference to FIG. 17. When the process of Step S103 ends, the process proceeds to Step S106.

In addition, when the current layer is determined to be an enhancement layer in Step S102, the process proceeds to Step S104. In Step S104, the encoding control section 102 decides a base layer corresponding to the current layer (i.e., sets the layer as a reference target).

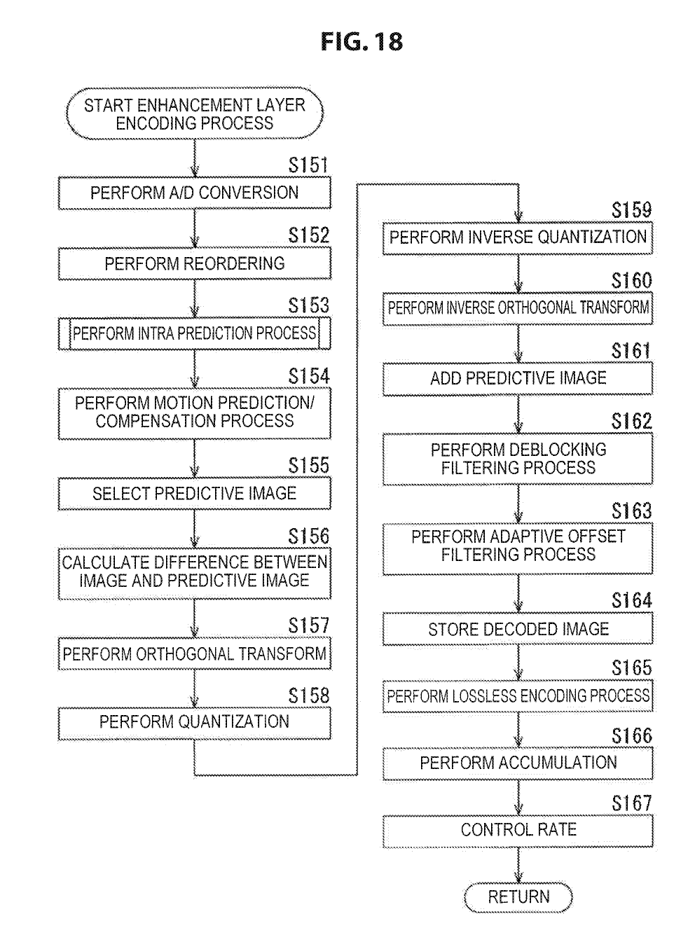

In Step S105, the enhancement layer image encoding section 105 performs an enhancement layer encoding process. Details of the enhancement layer encoding process will be described below with reference to FIG. 18. When the process of Step S105 ends, the process proceeds to Step S106.

In Step S106, the encoding control section 102 determines whether or not all the layers have been processed. When it is determined that there is a non-processed main layer, the process proceeds to Step S107.

In Step S107, the encoding control section 102 sets a next non-processed layer as a processing target (current layer). When the process of Step S107 ends, the process returns to Step S102. The process of Steps S102 to S107 is repeatedly performed to encode each of the layers as described above.

Then, when all the layers are determined to have been processed in Step S106, the encoding process ends.

### [Flow of a Base Layer Encoding Process]

Next, an example of the flow of the base layer encoding process executed in Step S103 of FIG. 16 will be described with reference to the flowchart of FIG. 17.

In Step S121, the A/D converting section 111 of the base layer image encoding section 103 performs A/D conversion on input image information (image data) of the base layer. In Step S122, the screen reordering buffer 112 stores image information (digital data) of the base layer that has been subjected to the A/D conversion, and reorders the pictures arranged in the display order in the encoding order.

In Step S123, the intra prediction section 124 performs the intra prediction process in the intra prediction mode. In Step S124, the motion prediction/compensation section 125 performs a motion prediction/compensation process in which motion prediction and motion compensation in the inter prediction mode are performed. In Step S125, the predictive image selecting section 126 decides an optimal mode based on the cost function values output from the intra prediction section 124 and the motion prediction/compensation section 125. In other words, the predictive image selecting section 126 selects either of the predictive image generated by the intra prediction section 124 and the predictive image generated by the motion prediction/compensation section 125. In Step S126, the operation section 113 calculates a difference between the image reordered in the process of Step S122 and the predictive image selected in the process of Step S125. The differential data is smaller in a data amount than the original image data. Thus, it is possible to compress a data amount to be smaller than when an image is encoded without change.

In Step S127, the orthogonal transform section 114 performs the orthogonal transform process on the differential information generated in the process of Step S126. In Step S128, the quantization section 115 quantizes the orthogonal transform coefficients obtained in the process of Step S127 using the quantization parameter calculated by the rate control section 127.

The differential information quantized in the process of Step S128 is locally decoded as follows. In other words, in Step S129, the inverse quantization section 118 performs inverse quantization on the quantized coefficients (which are also referred to as “quantization coefficients”) quantized in the process of Step S128 according to characteristics corresponding to characteristics of the quantization section 115. In Step S130, the inverse orthogonal transform section 119 performs the inverse orthogonal transform on the orthogonal transform coefficients obtained in the process of Step S127. In Step S131, the operation section 120 generates a locally decoded image (an image corresponding to an input of the operation section 113) by adding the predictive image to the locally decoded differential information.

The deblocking filter 121 performs in Step S132 a deblocking filtering process on the image generated from the process of Step S131. Accordingly, block distortion or the like is removed. In Step S133, the adaptive offset filter 128 performs an adaptive offset filtering process for mainly removing ringing on the deblocking filtering process result from the deblocking filter 121.

In Step S134, the frame memory 122 stores the image from which ringing or the like has been removed through the process of Step S133. It should be noted that images that have not undergone the filtering process by the deblocking filter 121 and the adaptive offset filter 128 are also supplied to the frame memory 122 from the operation section 120 and stored. The images stored in the frame memory 122 are used in the process of Step S123 and the process of Step S124.

In Step S135, the frame memory 122 also stores the stored images in the base layer decoded image memory 163 as base layer decoded image information. The base layer decoded image information from the frame memory 122 is also supplied to the up-sampling section 165.

In Step S136, the up-sampling section 165 up-samples the base layer decoded image information from the frame memory 122 of the base layer image encoding section 103 to the resolution of the enhancement layer. Then, the up-sampling section 165 stores the up-sampled base layer decoded image information in the frame memory 122 of the enhancement layer image encoding section 105.

In Step S137, the lossless encoding section 116 of the base layer image encoding section 103 encodes the coefficients quantized in the process of Step S128. In other words, lossless coding such as variable length coding or arithmetic coding is performed on data corresponding to the differential image.

At this time, the lossless encoding section 116 encodes information related to the prediction mode of the predictive image selected in the process of Step S125, and adds the encoded information to the encoded data obtained by encoding the differential image. In other words, the lossless encoding section 116 also encodes, for example, information according to the optimal intra prediction mode information supplied from the intra prediction section 124 or the optimal inter prediction mode supplied from the motion prediction/compensation section 125, and adds the encoded information to the encoded data.

In Step S138, the accumulation buffer 117 accumulates the base layer encoded data obtained in the process of Step S137. The base layer encoded data accumulated in the accumulation buffer 117 is appropriately read and transmitted to the decoding side via a transmission path or a recording medium.

In Step S139, the rate control section 127 controls the quantization operation of the quantization section 115 based on the coding amount (the generated coding amount) of the encoded data accumulated in the accumulation buffer 117 in the process of Step S138 so that no overflow or underflow occurs.

When the process of Step S139 ends, the base layer encoding process ends, and the process returns to the process of FIG. 16. The base layer encoding process is executed in, for example, units of pictures. That is to say, the base layer encoding process is executed on each picture of the current layer. However, respective processes of the base layer encoding process are performed in processing units thereof.

### [Flow of an Enhancement Layer Encoding Process]

Next, an example of the flow of the enhancement layer encoding process executed in Step S105 of FIG. 16 will be described with reference to the flowchart of FIG. 18.

The processes of Step S151, Step S152, and Steps S154 to S167 of the enhancement layer encoding process are executed in the same manner as the processes of Step S121, Step S122, Steps S124 to S134, and Steps S137 to S139 of the base layer encoding process of FIG. 17, respectively. However, each process of the enhancement layer encoding process is performed on the enhancement layer image information by the processing sections of the enhancement layer image encoding section 105.

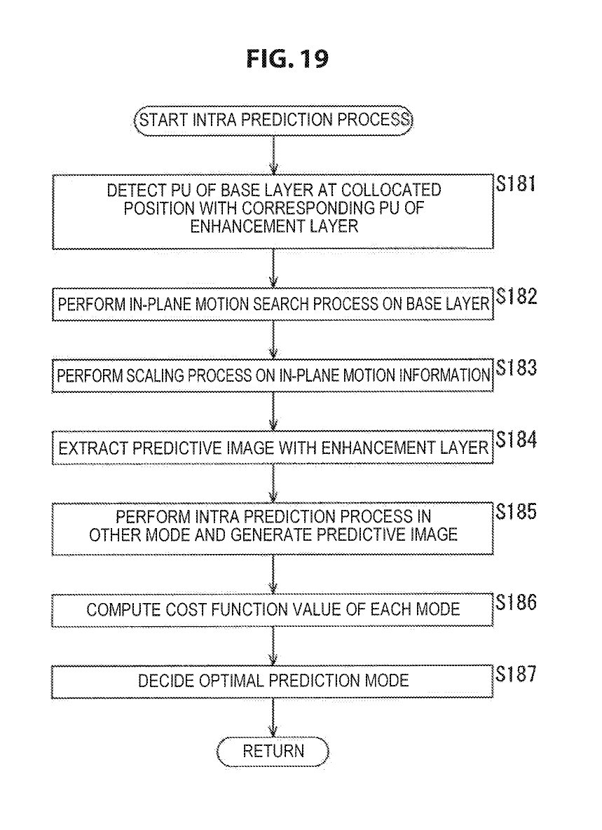

It should be noted that, in Step S153, the intra prediction section 134 of the enhancement layer image encoding section 105 performs an intra prediction process on the enhancement layer image information. Details of this intra prediction process will be described below with reference to FIG. 19.

When the process of Step S167 ends, the enhancement layer encoding process ends, and the process returns to FIG. 16. The enhancement layer encoding process is executed in, for example, units of pictures. That is to say, the enhancement layer encoding process is executed on each picture of the current layer. However, the respective processes of the enhancement layer encoding process are performed in processing units thereof.

### [Flow of an Intra Prediction Process]

Next, an example of the flow of the intra process executed in Step S153 of FIG. 18 will be described with reference to the flowchart of FIG. 19.

When the intra prediction process of the enhancement layer starts, the address register 151 of the intra prediction section 134 of the enhancement layer image encoding section 105 supplies information relating to the address of a corresponding PU of the enhancement layer to the ColBase detection section 161. With regard to this, the ColBase detection section 161 detects a PU of the base layer at the collocated position with the corresponding PU of the enhancement layer (ColBase PU) in Step S181. The ColBase detection section 161 supplies the address of the detected ColBase PU to the block matching section 162.

In Step S182, the block matching section 162 performs an in-screen motion search process on the base layer. Using the address of the ColBase PU from the ColBase detection section 161, the block matching section 162 performs an in-screen motion search of block matching on, for example, the ColBase PU from the base layer decoded image information accumulated in the base layer decoded image memory 163. The block matching section 162 supplies the in-screen motion information that is the result of the in-screen motion search to the scaling section 164.

In Step S183, the scaling section 164 performs a scaling process on the in-screen motion information. That is to say, the scaling section 164 scales the in-screen motion information from the block matching section 162 to the resolution of the enhancement layer, and supplies the scaled in-screen motion information to the in-screen motion compensation section 152.

In Step S184, the in-screen motion compensation section 152 refers to the reference image from the frame memory 122 to extract a predictive image using the in-screen motion information scaled by the scaling section 164, and supplies the extracted predictive image to the cost function computation section 153.

In Step S185, the in-screen motion compensation section 152 refers to the reference image from the frame memory 122 to generate a predictive image in another intra prediction mode of HEVC, and supplies the generated predictive image to the cost function computation section 153.

In Step S186, the cost function computation section 153 computes the cost function values of respective modes (that is, the prediction mode of the in-screen motion search of the present technology and other intra prediction modes). The cost function computation section 153 supplies the computed cost function values to the mode determination section 154 together with the predictive images of the respective modes.

In Step S187, the mode determination section 154 decides the prediction mode in which the cost function value computed by the cost function computation section 153 becomes the minimum as the optimal prediction mode. The mode determination section 154 supplies information relating to the decided optimal prediction mode to the lossless encoding section 116 and supplies the predictive images to the operation section 113.

When the process of Step S187 ends, the intra prediction process ends, and the process returns to the process of FIG. 18.

By executing the respective processes as described above, the scalable encoding device 100 can improve encoding efficiency in the enhancement layer.

### 2. Second Embodiment

### <Scalable Decoding Device>

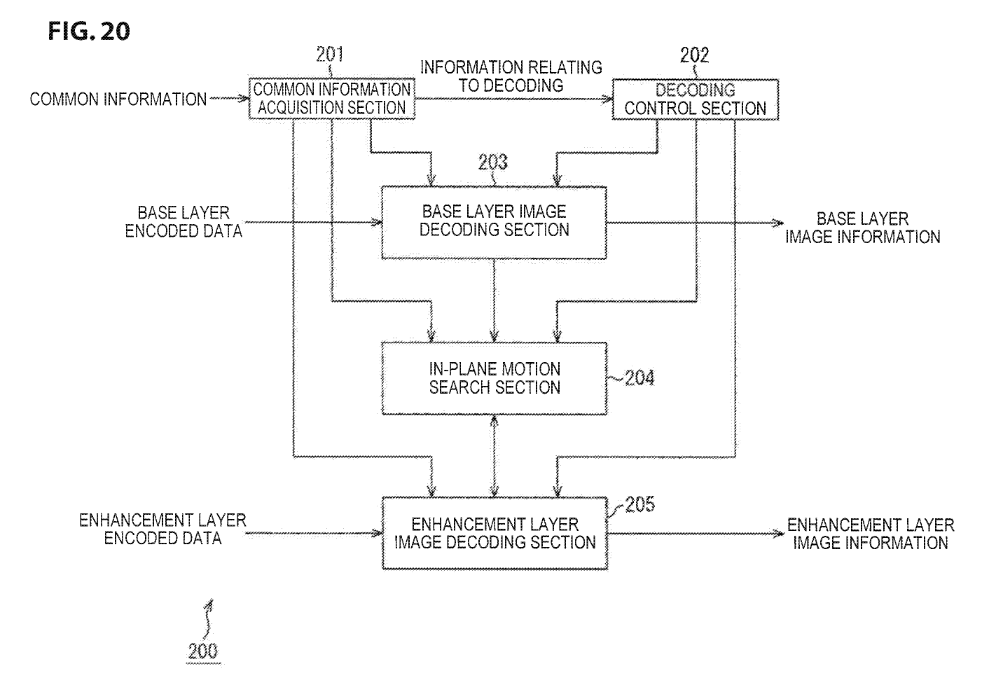

Next, decoding of the encoded data (bitstream) that has been subjected to the scalable video coding as described above will be described. FIG. 20 is a block diagram illustrating an example of a main configuration of a scalable decoding device corresponding to the scalable encoding device 100 of FIG. 12. For example, a scalable decoding device 200 illustrated in FIG. 20 performs scalable decoding on the encoded data obtained by performing the scalable encoding on the image data through the scalable encoding device 100 according to a method corresponding to the encoding method.

As illustrated in FIG. 20, the scalable decoding device 200 has a common information acquisition section 201, a decoding control section 202, a base layer image decoding section 203, an in-screen motion search section 204, and an enhancement layer image decoding section 205.

The common information acquisition section 201 acquires common information (for example, a video parameter set (VPS)) transmitted from the encoding side. The common information acquisition section 201 extracts information relating to decoding from the acquired common information, and supplies the information to the decoding control section 202. In addition, the common information acquisition section 201 appropriately supplies some or all of the common information to the base layer image decoding section 203 to the enhancement layer image decoding section 205.

The decoding control section 202 acquires the information relating to decoding supplied from the common information acquisition section 201, and controls decoding of each layer by controlling the base layer image decoding section 203 to the enhancement layer image decoding section 205 based on the information.

The base layer image decoding section 203 is an image decoding section corresponding to the base layer image encoding section 103, and acquires, for example, base layer encoded data obtained by encoding the base layer image information by the base layer image encoding section 103. The base layer image decoding section 203 decodes the base layer encoded data without using information of another layer to reconstruct and output the base layer image information. In addition, the base layer image decoding section 203 supplies the base layer decoded image information obtained during decoding to the in-screen motion search section 204.

The in-screen motion search section 204 receives supply of the address of the current block (corresponding PU) of the enhancement layer, and supply of the base layer decoded image information from the base layer image decoding section 203.

The in-screen motion search section 204 detects the ColBase block (ColBase PU) corresponding to the current block (corresponding PU) of the enhancement layer in the base layer decoded image information from the base layer image decoding section 203, and performs in-screen search on the ColBase block. Then, the in-screen motion search section 204 supplies in-screen motion information obtained as a result of the in-screen search to the enhancement layer image decoding section 205.

The enhancement layer image decoding section 205 is an image decoding section corresponding to the enhancement layer image encoding section 105. The enhancement layer image decoding section 205 acquires, for example, enhancement layer encoded data obtained by the enhancement layer image encoding section 105 encoding the enhancement layer image information. The enhancement layer image decoding section 205 decodes the enhancement layer encoded data. In this case, the enhancement layer image decoding section 205 decodes the enhancement layer image information using not only information of the enhancement layer but also the information of the base layer up-sampled by the in-screen motion search section 204 as necessary.

In addition, when intra prediction mode information supplied from the common information acquisition section 201 is a prediction mode of the in-screen motion search of the present technology that is one intra prediction mode, the enhancement layer image decoding section 205 supplies address information of the current block to the in-screen motion search section 204 in order to obtain in-screen motion information that is the result of the in-screen search for the ColBase block of the current block in the base layer decoded image information. The enhancement layer image decoding section 205 performs the in-screen search on the ColBase block with the in-screen motion search section 204 to acquire the in-screen motion information obtained as a result of the search. The enhancement layer image decoding section 205 generates a predictive image of the current block using the in-screen motion information obtained as above, and reconstructs and outputs the enhancement layer image information using the predictive image.

### [Base Layer Image Decoding Section]

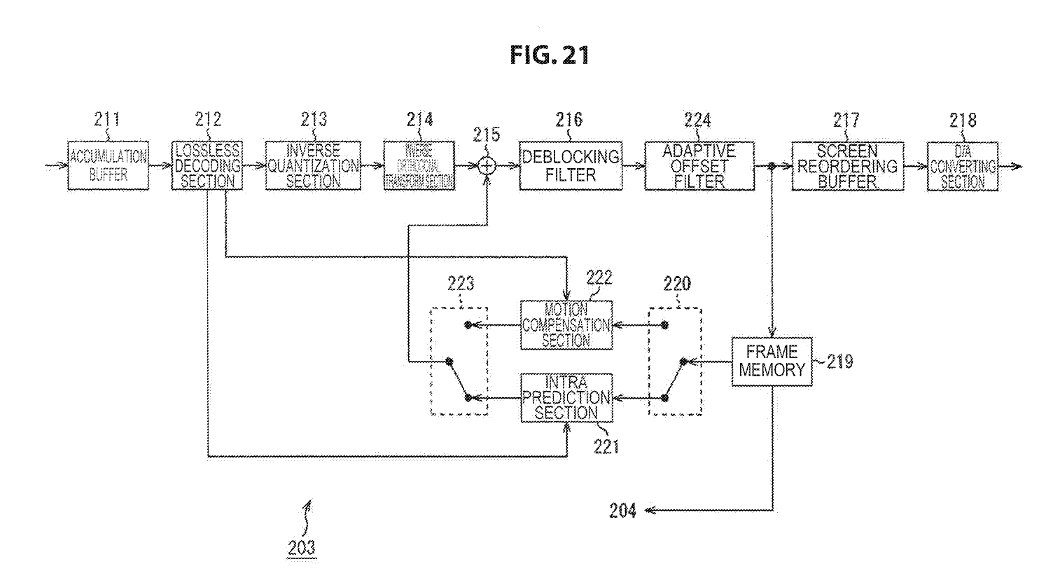

FIG. 21 is a block diagram illustrating an example of a main configuration of the base layer image decoding section 203 of FIG. 20. The base layer image decoding section 203 has an accumulation buffer 211, a lossless decoding section 212, an inverse quantization section 213, an inverse orthogonal transform section 214, an operation section 215, a deblocking filter 216, a screen reordering buffer 217, and a D/A converting section 218 as illustrated in FIG. 21. In addition, the base layer image decoding section 203 has a frame memory 219, a selecting section 220, an intra prediction section 221, a motion compensation section 222, and a selecting section 223. Furthermore, the base layer image decoding section 203 has an adaptive offset filter 224 between the deblocking filter 216, and the screen reordering buffer 217 and the frame memory 219.

The accumulation buffer 211 is a receiving section that receives the transmitted base layer encoded data. The accumulation buffer 211 receives and accumulates the transmitted base layer encoded data, and supplies the encoded data to the lossless decoding section 212 at a certain timing. Information necessary for decoding of the prediction mode information or the like is added to the base layer encoded data.

The lossless decoding section 212 decodes the information that has been encoded by the lossless encoding section 116 and supplied from the accumulation buffer 211 according to a scheme corresponding to the encoding scheme of the lossless encoding section 116. The lossless decoding section 212 supplies quantized coefficient data of a differential image obtained by the decoding to the inverse quantization section 213.

Further, the lossless decoding section 212 appropriately extracts and acquires the NAL unit including the video parameter set (VPS), the sequence parameter set (SPS), the picture parameter set (PPS), and the like which are included in the base layer encoded data. The lossless decoding section 212 extracts the information related to the optimal prediction mode from the information, determines which of the intra prediction mode and the inter prediction mode has been selected as the optimal prediction mode based on the information. The lossless decoding section 212 supplies the information related to the optimal prediction mode to one of the intra prediction section 221 and the motion compensation section 222 that corresponds to the mode determined to have been selected. In other words, for example, in the base layer image encoding section 103, when the intra prediction mode is selected as the optimal prediction mode, the information related to the optimal prediction mode is supplied to the intra prediction section 221. Further, for example, in the base layer image encoding section 103, when the inter prediction mode is selected as the optimal prediction mode, the information related to the optimal prediction mode is supplied to the motion compensation section 222.

The lossless decoding section 212 extracts information necessary for inverse quantization such as the quantization matrix or the quantization parameter from the NAL unit, and supplies the extracted information to the inverse quantization section 213.

The inverse quantization section 213 inversely quantizes the quantized coefficient data obtained through the decoding performed by the lossless decoding section 212 according to a scheme corresponding to the quantization scheme of the quantization section 115. The inverse quantization section 213 is the same processing section as the inverse quantization section 118. In other words, the description of the inverse quantization section 213 can be applied to the inverse quantization section 118 as well. Here, it is necessary to appropriately change and read a data input/output destination or the like according to a device. The inverse quantization section 213 supplies the obtained coefficient data to the inverse orthogonal transform section 214.

The inverse orthogonal transform section 214 performs the inverse orthogonal transform on the coefficient data supplied from the inverse quantization section 213 according to a scheme corresponding to the orthogonal transform scheme of the orthogonal transform section 114. The inverse orthogonal transform section 214 is the same processing section as the inverse orthogonal transform section 119. In other words, the description of the inverse orthogonal transform section 214 can be applied to the inverse orthogonal transform section 119 as well. Here, it is necessary to appropriately change and read a data input/output destination or the like according to a device

The inverse orthogonal transform section 214 obtains decoded residual data corresponding to residual data that is not subjected to the orthogonal transform in the orthogonal transform section 114 through the inverse orthogonal transform process. The decoded residual data obtained through the inverse orthogonal transform is supplied to the operation section 215. Further, the predictive image is supplied from the intra prediction section 221 or the motion compensation section 222 to the operation section 215 via the selecting section 223.

The operation section 215 adds the decoded residual data and the predictive image, and obtains decoded image data corresponding to the image data from which the predictive image is not subtracted by the operation section 113. The operation section 215 supplies the decoded image data to the deblocking filter 216.

The deblocking filter 216 removes block distortion of the decoded image by performing a deblocking filtering process on the decoded image. The deblocking filter 216 supplies the image that has undergone the filtering process to the adaptive offset filter 224.

The adaptive offset filter 224 performs an adaptive offset filtering (sample adaptive offset, or SAO) process for removing mainly ringing on the result of the deblocking filtering process (decoded image on which removal of block distortion has been performed) from the deblocking filter 216.

The adaptive offset filter 224 receives an offset and the type of adaptive offset filtering process for each largest coding unit (LCU) that is the largest encoding unit from the lossless decoding section 212, which is not illustrated. The adaptive offset filter 224 performs the adaptive offset filtering process of the received type on the image that has undergone the adaptive deblocking filtering process using the received offset. Then, the adaptive offset filter 224 supplies the image that has undergone the adaptive offset filtering process (hereinafter referred to as a decoded image) to the screen reordering buffer 217 and the frame memory 219.

It should be noted that the decoded image output from the operation section 215 can be supplied to the screen reordering buffer 217 and the frame memory 219 without passing the deblocking filter 216 and the adaptive offset filter 224. That is to say, a part or all of the filtering process by the deblocking filter 216 and the adaptive offset filter 224 can be omitted. In addition, an adaptive loop filter may be provided in the latter stage of the adaptive offset filter 224.

The screen reordering buffer 217 reorders the decoded image. In other words, the order of the frames reordered in the encoding order by the screen reordering buffer 112 is reordered in the original display order. The D/A converting section 218 performs D/A conversion on the image supplied from the screen reordering buffer 217, and outputs the converted image to be displayed on a display (not illustrated).

The frame memory 219 stores the supplied decoded image, and supplies the stored decoded image to the selecting section 220 as the reference image at a certain timing or based on an external request, for example, from the intra prediction section 221, the motion compensation section 222, or the like. In addition, the frame memory 219 supplies this decoded image to the in-screen motion search section 204 as base layer decoded image information.

The selecting section 220 selects the supply destination of the reference image supplied from the frame memory 219. When an image encoded by the intra coding is decoded, the selecting section 220 supplies the reference image supplied from the frame memory 219 to the intra prediction section 221. Further, when an image encoded by the inter coding is decoded, the selecting section 220 supplies the reference image supplied from the frame memory 219 to the motion compensation section 222.

For example, the information indicating the intra prediction mode obtained by decoding the header information is appropriately supplied from the lossless decoding section 212 to the intra prediction section 221. The intra prediction section 221 generates the predictive image by performing the intra prediction using the reference image acquired from the frame memory 219 in the intra prediction mode used in the intra prediction section 124 on the encoding side. The intra prediction section 221 supplies the generated predictive image to the selecting section 223.

The motion compensation section 222 acquires information (optimal prediction mode information, reference image information, and the like) obtained by decoding the header information from the lossless decoding section 212.

The motion compensation section 222 generates the predictive image by performing the inter prediction using the reference image acquired from the frame memory 219 in the motion prediction indicated by the optimal prediction mode information acquired from the lossless decoding section 212.

The motion compensation section 222 supplies the generated predictive image to the selecting section 223. In addition, the motion compensation section 222 supplies the motion information of the current block used in the generation (motion compensation) of the predictive image to the in-screen motion search section 204 as the base layer motion information.

The selecting section 223 supplies the predictive image supplied from the intra prediction section 221 or the predictive image supplied from the motion compensation section 222 to the operation section 215. Then, the operation section 215 adds the predictive image generated using the motion vector to the decoded residual data (the differential image information) supplied from the inverse orthogonal transform section 214 to decode the original image.

### [Enhancement Layer Image Decoding Section]

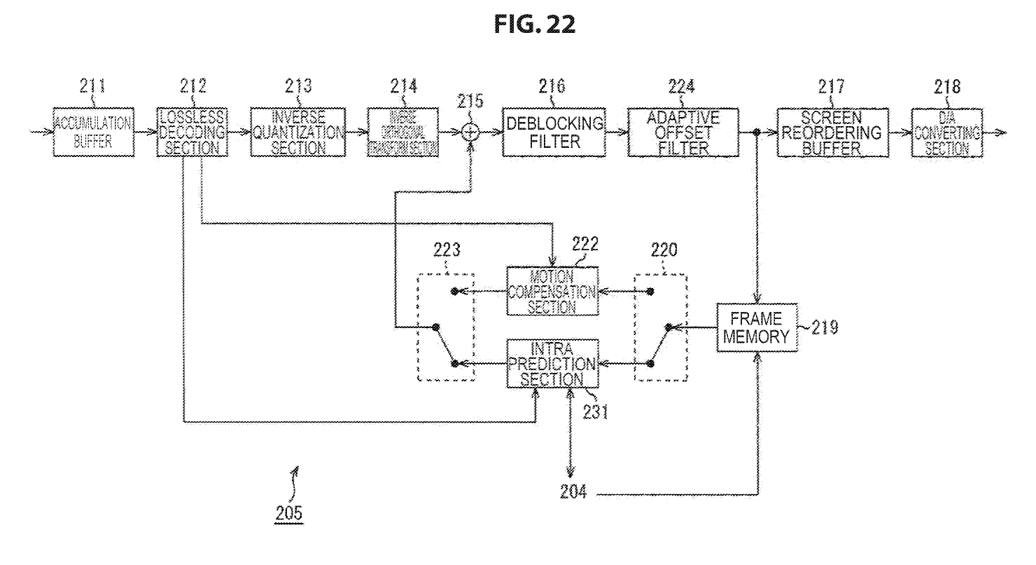

FIG. 22 is a block diagram illustrating an example of a main configuration of the enhancement layer image decoding section 205 of FIG. 20. As illustrated in FIG. 22, the enhancement layer image decoding section 205 basically has the same configuration as the base layer image decoding section 203 of FIG. 21.

However, each section of the enhancement layer image decoding section 205 performs a process relating to decoding of encoded data of the enhancement layer, rather than the base layer. That is to say, the accumulation buffer 211 of the enhancement layer image decoding section 205 stores the encoded data of the enhancement layer, and the D/A converting section 218 of the enhancement layer image decoding section 205 outputs enhancement layer image information to, for example, a recording device (recording medium), a transmission path, or the like in the latter stage, which is not illustrated.

In addition, the enhancement layer image decoding section 205 has an intra prediction section 231 in place of the intra prediction section 221. Information indicating an intra prediction mode obtained by decoding header information or the like is appropriately supplied from the lossless decoding section 212 to the intra prediction section 231. It should be noted that, when the above-described search range, in-screen motion information, differential in-screen motion information, or the like is transmitted from the encoding side, the information is extracted by the lossless decoding section 212 from the NAL unit or the like, and is supplied to the intra prediction section 231 or the in-screen motion search section 204.

When the intra prediction mode used in the intra prediction section 134 of the encoding side is the prediction mode of the in-screen motion search of the present technology, the intra prediction section 231 supplies address information of the current block to the in-screen motion search section 204 in order to obtain in-screen motion information that is the result from the in-screen search on the ColBase block of the current block. Then, the intra prediction section 231 performs in-screen search on the ColBase block with the in-screen motion search section 204 to acquire the in-screen motion information from the result, and generates the predictive image of the current block using the acquired in-screen motion information. The intra prediction section 231 supplies the generated predictive image to the selecting section 223.

### [Intra Prediction Section and In-Screen Motion Search Section]

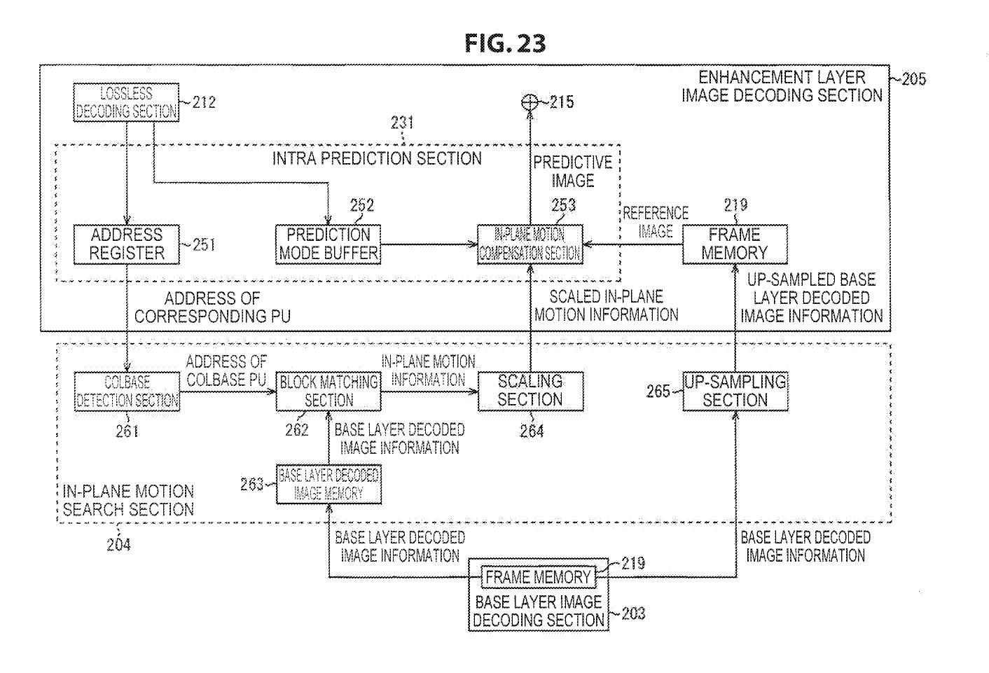

FIG. 23 is a block diagram illustrating an example of a main configuration of the intra prediction section 231 of FIG. 22 and the in-screen motion search section 204 of FIG. 20.

As illustrated in FIG. 23, the intra prediction section 231 has an address register 251, a prediction mode buffer 252, and an in-screen motion compensation section 253.

The in-screen motion search section 204 basically has the same configuration as the in-screen motion search section 104, and has a ColBase detection section 261, a block matching section 262, a base layer decoded image memory 263, a scaling section 264, and an up-sampling section 265. In other words, the ColBase detection section 261, the block matching section 262, the base layer decoded image memory 263, the scaling section 264, and the up-sampling section 265 correspond to the ColBase detection section 161, the block matching section 162, the base layer decoded image memory 163, the scaling section 164, and the up-sampling section 165, respectively.

Information indicating the prediction mode of the corresponding PU from the lossless decoding section 212 is supplied to the prediction mode buffer 252. In addition, when the information indicating the prediction mode indicates the prediction mode of in-screen motion search of the present technology, a control signal is supplied from the lossless decoding section 212 to the address register 251.

When the address register 251 receives the control signal from the lossless decoding section 212, the register supplies information relating to the address of the corresponding PU that is the current block to the ColBase detection section 261.

The prediction mode buffer 252 receives and accumulates the information indicating the prediction mode from the lossless decoding section 212, and supplies the information to the in-screen motion compensation section 253 at a predetermined timing.

The in-screen motion compensation section 253 receives supply of the information indicating the prediction mode from the prediction mode buffer 252, supply of the in-screen motion information that has been scaled by the scaling section 264, and supply of the reference image from the frame memory 219.

When the information indicating the prediction mode indicates the prediction mode of the in-screen motion search of the present technology, the in-screen motion compensation section 253 refers to the reference image from the frame memory 219, extracts a predictive image using the in-screen motion information scaled from the scaling section 264, and supplies the extracted predictive image to the operation section 215.

In addition, when the information indicating the prediction mode indicates an intra prediction mode of HEVC other than the prediction mode of the in-screen motion search of the present technology, the in-screen motion compensation section 253 refers to the reference image from the frame memory 219 to generate a predictive image in the intra prediction mode of HEVC, and supplies the generated predictive image to the operation section 215.

Using the information relating to the address of the corresponding PU supplied from the address register 251, the ColBase detection section 261 computes the address of the collocated block (ColBase PU) corresponding to the address of the corresponding PU of the enhancement layer for the base layer. The ColBase detection section 261 supplies the computed address of the ColBase PU to the block matching section 262.

Using the address of the ColBase PU from the ColBase detection section 261, the block matching section 262 performs, for example, an in-screen motion search of block matching on the ColBase PU from the base layer decoded image information accumulated in the base layer decoded image memory 263. The block matching section 262 supplies the in-screen motion information that is the result of the in-screen motion search to the scaling section 264.

The base layer decoded image information is supplied from the frame memory 219 of the base layer image decoding section 203 to the base layer decoded image memory 263 and the up-sampling section 265.

The base layer decoded image memory 263 accumulates the base layer decoded image information from the frame memory 219 of the base layer image decoding section 203. The base layer decoded image memory 263 supplies the accumulated base layer decoded image information to the block matching section 262.

The scaling section 264 scales the in-screen motion information from the block matching section 262 to the resolution of the enhancement layer, and supplies the scaled in-screen motion information to the in-screen motion compensation section 253.

The up-sampling section 265 performs up-sampling on the base layer decoded image information from the frame memory 219 of the base layer image decoding section 203 to the resolution of the enhancement layer. The up-sampling section 265 supplies the up-sampled base layer decoded image information to the frame memory 219 of the enhancement layer image decoding section 205.

As described above, when the information indicating the prediction mode of the in-screen motion search of the present technology that is one intra prediction of the enhancement layer has been sent, the scalable decoding device 200 performs an in-screen motion search on the corresponding block of the base layer corresponding to the current block of the enhancement layer. Then, the scalable decoding device 200 generates a predictive image of the current block of the enhancement layer using the in-screen motion information that is the result of the search.

Since the encoding process on the base layer has already ended when the encoding process is performed on the enhancement layer, the in-screen motion search process on the base layer described above can be performed in parallel with the encoding process of the enhancement layer.

In addition, since the base layer and the enhancement layer have a high correlation in texture information in scalable video coding, the in-screen motion search process on the base layer described above can be detected to have a high correlation with the enhancement layer.

Accordingly, encoding efficiency with respect to the enhancement layer can be improved.

### [Flow of a Decoding Process]

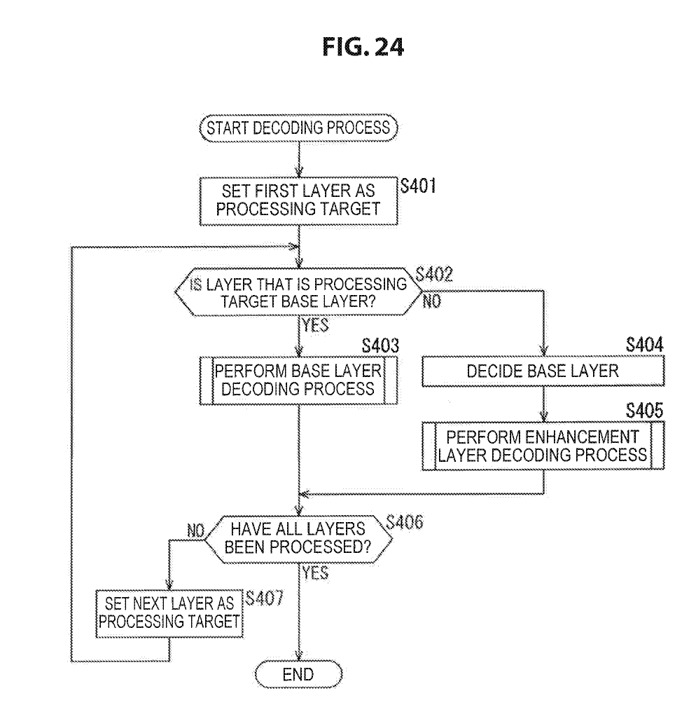

Next, the flow of each process executed by the scalable decoding device 200 as above will be described. First, an example of the flow of a decoding process will be described with reference to the flowchart of FIG. 24. The scalable decoding device 200 executes the decoding process for each picture.

When the decoding process starts, the decoding control section 202 of the scalable decoding device 200 sets the first layer as a processing target in Step S401.

In Step S402, the decoding control section 202 determines whether or not the current layer that is the processing target is a base layer. When the current layer is determined to be a base layer, the process proceeds to Step S403.

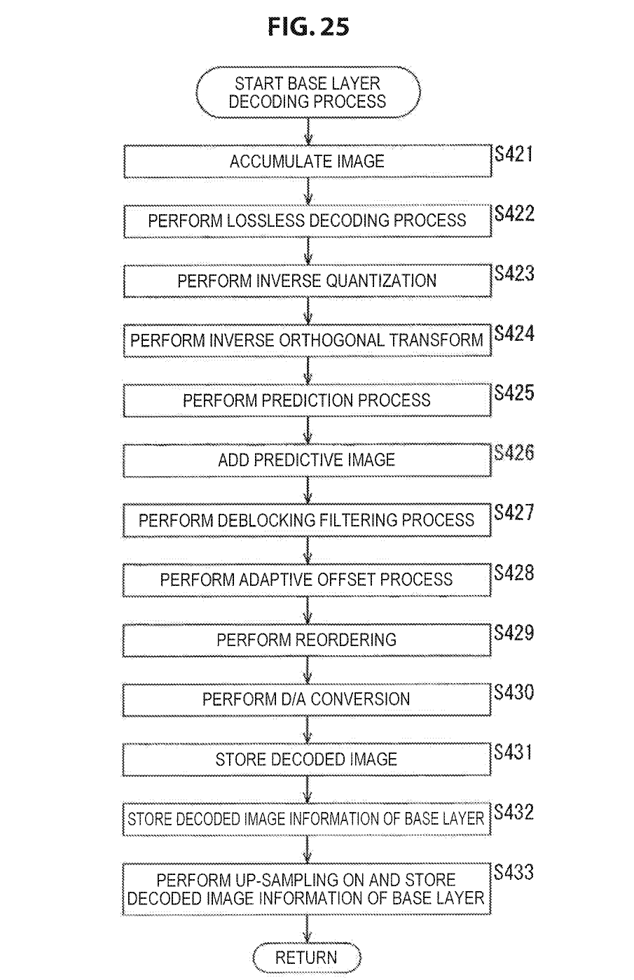

In Step S403, the base layer image decoding section 203 performs a base layer decoding process. Details of the base layer decoding process will be described below with reference to FIG. 25. When the process of Step S403 ends, the process proceeds to Step S406.

In addition, when the current layer is determined to be an enhancement layer in Step S402, the process proceeds to Step S404. In Step S404, the decoding control section 202 decides a base layer corresponding to the current layer (i.e., sets the layer as a reference target).

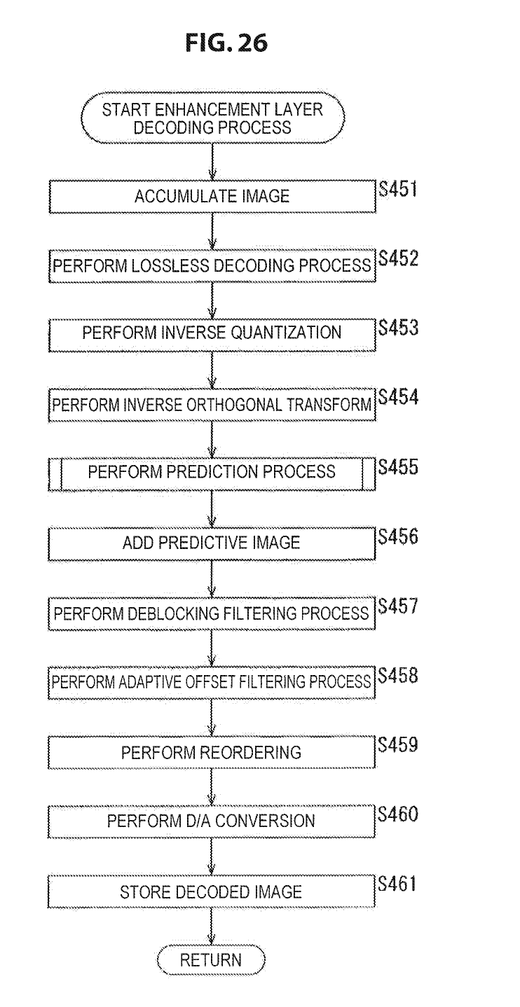

In Step S405, the enhancement layer image decoding section 205 performs an enhancement layer decoding process. Details of the enhancement layer decoding process will be described below with reference to FIG. 26. When the process of Step S405 ends, the process proceeds to Step S406.

In Step S406, the decoding control section 202 determines whether or not all layers have been processed. When it is determined that there is an unprocessed layer, the process proceeds to Step S407.

In Step S407, the decoding control section 202 sets the next unprocessed layer as a processing target (current layer). When the process of Step S407 ends, the process returns to Step S402. The processes of Step S402 to Step S407 are repeated to decode each of layers.

Then, when all layers are determined to have been processed in Step S406, the decoding process ends.

### [Flow of the Base Layer Decoding Process]

Next, an example of the flow of the base layer decoding process executed in Step S403 of FIG. 24 will be described with reference to the flowchart of FIG. 25.

When the base layer decoding process starts, in Step S421, the accumulation buffer 211 of the base layer image decoding section 203 accumulates the bitstreams of the base layer transmitted from the encoding side. In Step S422, the lossless decoding section 212 decodes the bitstream (the encoded differential image information) of the base layer supplied from the accumulation buffer 211. In other words, the I picture, the P picture, and the B picture encoded by the lossless encoding section 116 are decoded. At this time, various kinds of information other than the differential image information included in the bitstream, such as the header information, are also decoded.

In Step S423, the inverse quantization section 213 inversely quantizes the quantized coefficients obtained in the process of Step S422.

In Step S424, the inverse orthogonal transform section 214 performs the inverse orthogonal transform on a current block (a current TU).

In Step S425, the intra prediction section 221 or the motion compensation section 222 performs the prediction process, and generates the predictive image. In other words, the prediction process is performed in the prediction mode that is determined to have been applied at the time of encoding in the lossless decoding section 212. More specifically, for example, when the intra prediction is applied at the time of encoding, the intra prediction section 221 generates the predictive image in the intra prediction mode recognized to be optimal at the time of encoding. Further, for example, when the inter prediction is applied at the time of encoding, the motion compensation section 222 generates the predictive image in the inter prediction mode recognized to be optimal at the time of encoding.

In Step S426, the operation section 215 adds the predictive image generated in Step S425 to the differential image information generated by the inverse orthogonal transform process of Step S424. As a result, the original image is decoded.

In Step S427, the deblocking filter 216 performs a deblocking filtering process on the decoded image obtained in Step S426. Accordingly, block distortion or the like is removed. In Step S428, the adaptive offset filter 224 performs an adaptive offset filtering process to mainly remove ringing on the deblocking filtering process result from the deblocking filter 216.

In Step S429, the screen reordering buffer 217 performs reordering of the image from which ringing or the like has been removed in Step S428. In other words, the order of frames rearranged for encoding by the screen reordering buffer 112 is reordered in the original display order.

In Step S430, the D/A converting section 218 performs D/A conversion on the image in which the order of the frames is reordered in Step S429. The image is output to a display (not illustrated), and the image is displayed.

In Step S431, the frame memory 219 stores the image that has been subjected to the adaptive offset filtering process in Step S428.

In Step S432, the frame memory 219 also stores the stored image in the base layer decoded image memory 263 as base layer decoded image information. The base layer decoded image information from the frame memory 219 is also supplied to the up-sampling section 265.

In Step S433, the up-sampling section 265 performs up-sampling on the base layer decoded image information from the frame memory 219 of the base layer image decoding section 203 to the resolution of the enhancement layer. The up-sampling section 265 stores in the frame memory 219 of the up-sampled enhancement layer image decoding section 205.

When the process of Step S433 ends, the base layer decoding process ends, and the process returns to the process of FIG. 24. The base layer decoding process is executed in, for example, units of pictures. That is to say, the base layer decoding process is executed for each picture of the current layer. However, the respective processes of the base layer decoding process are performed in processing units thereof.

### [Flow of the Enhancement Layer Decoding Process]

Next, an example of the flow of the enhancement layer decoding process executed in Step S405 of FIG. 24 will be described with reference to the flowchart of FIG. 26.

The processes of Steps S451 to S454 and Steps S456 to S461 of the enhancement layer decoding process are executed in the same manner as those of Steps S421 to S424 and Steps S426 to S431 of the base layer decoding process, respectively. However, the respective processes of the enhancement layer decoding process are performed on enhancement layer encoded data by respective processing sections of the enhancement layer image decoding section 205.

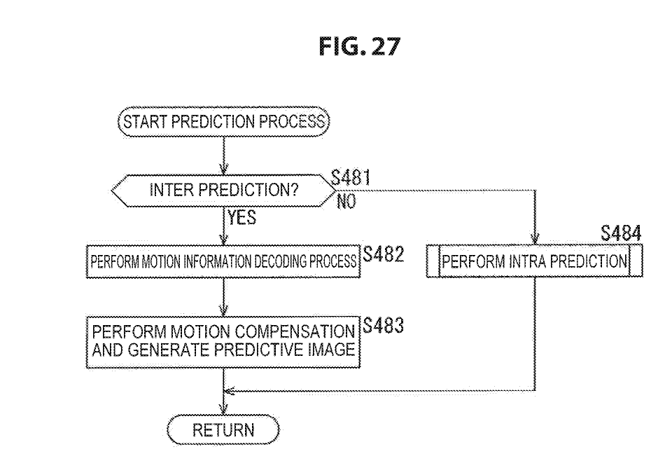

It should be noted that, in Step S455, the intra prediction section 231 and the motion compensation section 222 perform a prediction process on the enhancement layer encoded data. Details of this prediction process will be described below with reference to FIG. 27.

When the process of Step S461 ends, the enhancement layer decoding process ends, and the process returns to the process of FIG. 24. The enhancement layer decoding process is executed in, for example, units of pictures. That is to say, the enhancement layer decoding process is executed on each picture of the current layer. However, the respective processes of the enhancement layer decoding process are performed in processing units thereof.

### [Flow of the Prediction Process]

Next, an example of the flow of the prediction process executed in Step S455 of FIG. 26 will be described with reference to the flowchart of FIG. 27.

When the prediction process starts, the motion compensation section 222 determines whether or not the prediction mode is inter prediction in Step S481. When it is determined to be inter prediction, the process proceeds to Step S482.

In Step S482, the motion compensation section 222 performs a motion information decoding process to reconstruct motion information of the current block.

In Step S483, the motion compensation section 222 performs motion compensation using the motion information obtained from the process of Step S482 to generate a predictive image. When the predictive image is generated, the prediction process ends, and the process returns to the process of FIG. 26.

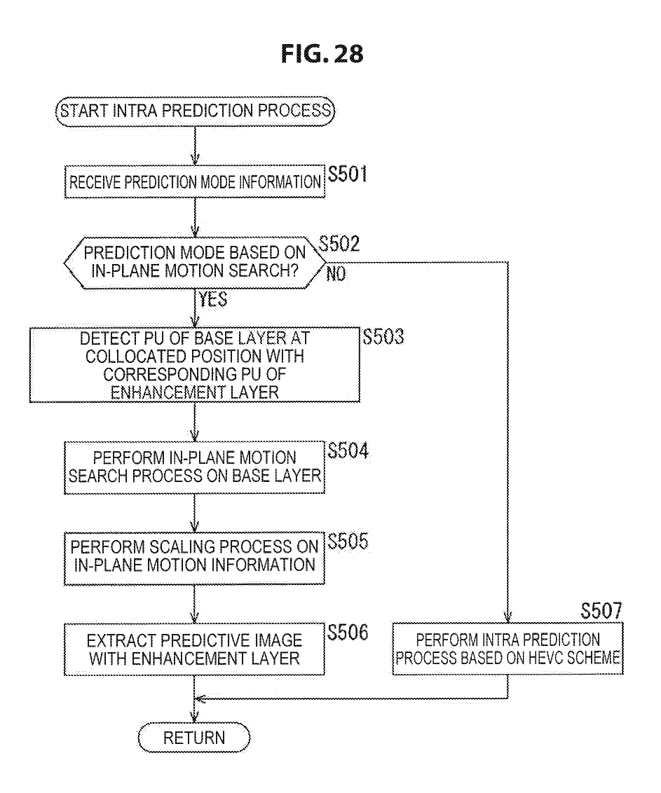

In addition, when intra prediction is determined in Step S481, the process proceeds to Step S484. In Step S484, the intra prediction section 231 performs intra prediction. Details of the intra prediction process will be described below with reference to FIG. 28. When the process of Step S484 ends, the prediction process ends, and the process returns to the process of FIG. 26.

### [Flow of the Intra Prediction Process]

Next, an example of the flow of the intra prediction process executed in Step S484 of FIG. 27 will be described with reference to FIG. 28.

Information indicating the prediction mode of the corresponding PU is supplied from the lossless decoding section 212 to the prediction mode buffer 252. The prediction mode buffer 252 of the intra prediction section 231 receives prediction mode information that is the information indicating the prediction mode of the enhancement layer transmitted from the encoding side from the lossless decoding section 212 in Step S501. The prediction mode buffer 252 supplies the prediction mode information to the in-screen motion compensation section 253.

In Step S502, the in-screen motion compensation section 253 determines whether or not the information is of the prediction mode of the in-screen motion search (of the present technology) based on the prediction mode information. When it is determined to be of the prediction mode of the in-screen motion search in Step S502, the process proceeds to Step S503. In this case, since a control signal is supplied from the lossless decoding section 212 to the address register 251, when the address register 251 receives the control signal from the lossless decoding section 212, information relating to the address of the corresponding PU that is a current block is supplied to the ColBase detection section 261.

In Step S503, the ColBase detection section 261 detects a PU of the base layer at the collocated position with the corresponding PU of the enhancement layer (ColBase PU). The ColBase detection section 261 supplies the address of the detected ColBase PU to the block matching section 262.

In Step S504, the block matching section 262 performs an in-screen motion search process on the base layer. Using the address of the ColBase PU from the ColBase detection section 261, the block matching section 262 performs, for example, an in-screen motion search of block matching on the ColBase PU from the base layer decoded image information accumulated in the base layer decoded image memory 263. The block matching section 262 supplies the in-screen motion information that is the result of the in-screen motion search to the scaling section 264.

In Step S505, the scaling section 264 performs a scaling process on the in-screen motion information. That is to say, the scaling section 264 scales the in-screen motion information from the block matching section 262 to the resolution of the enhancement layer, and supplies the scaled in-screen motion information to the in-screen motion compensation section 253.

In Step S506, the in-screen motion compensation section 253 refers to the reference image from the frame memory 219, extracts a predictive image using the in-screen motion information scaled by the scaling section 264, and supplies the extracted predictive image to the operation section 215. When the process of Step S506 ends, the intra prediction process ends, and the process returns to the process of FIG. 27.

On the other hand, when it is determined not to be of the prediction mode of the in-screen motion search in Step S502, the process proceeds to Step S507. In this case, a control signal is not supplied from the lossless decoding section 212 to the address register 251.

In Step S507, the in-screen motion compensation section 253 performs the intra prediction process based on the HEVC scheme in the prediction mode from the prediction mode buffer 252. The in-screen motion compensation section 253 supplies a predictive image obtained from the result to the operation section 215. When the process of Step S507 ends, the intra prediction process ends, and the process returns to the process of FIG. 27.

By executing the respective processes as described above, the scalable decoding device 200 can improve encoding efficiency of the enhancement layer.

### 3. Others

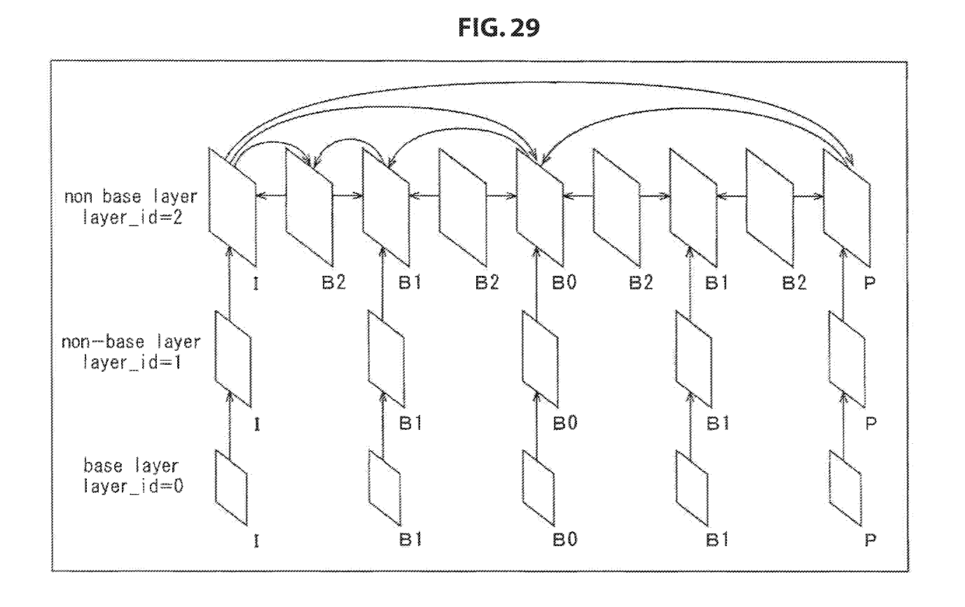

Although the example in which image data is hierarchized into a plurality of layers by scalable video coding has been described above, the number of layers is arbitrary. For example, as an example shows in FIG. 29, some pictures may be hierarchized. Further, although the example in which the enhancement layer is processed using information on the base layer at the time of encoding and decoding has been described above, the present technology is not limited to this example, and the enhancement layer may be processed using information on any other processed enhancement layer.

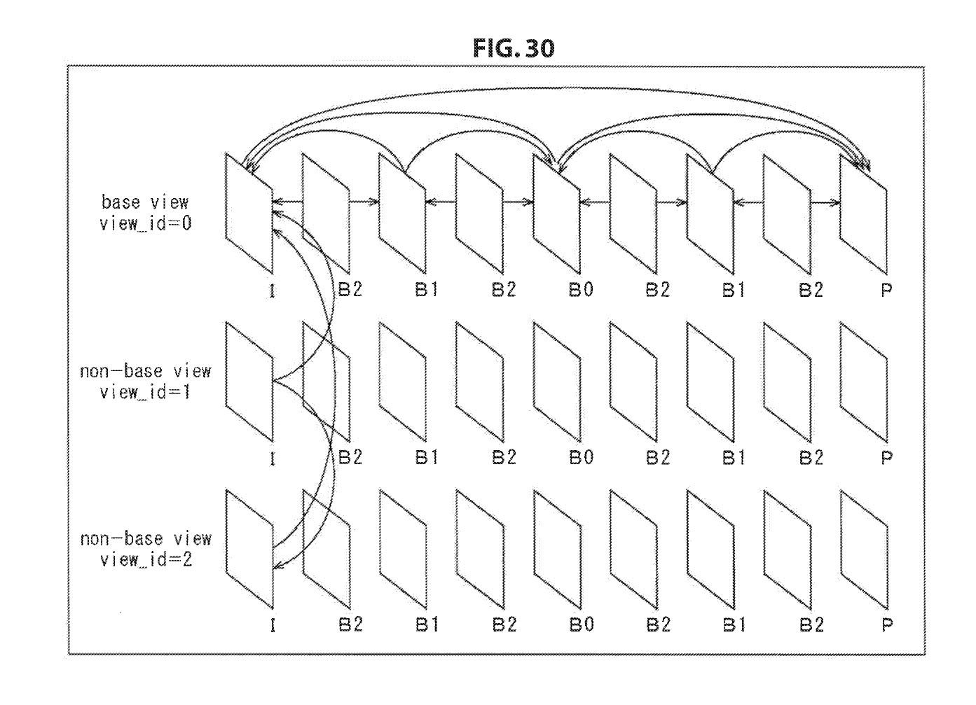

Further, a view in multi-view image encoding and decoding is also included as a layer described above. In other words, the present technology can be applied to multi-view image encoding and multi-view image decoding. FIG. 30 illustrates an example of a multi-view image encoding scheme.

As illustrated in FIG. 30, a multi-view image includes images of a plurality of views, and an image having one predetermined view among the plurality of views is designated to be a base view image. Images of respective views other than the base view image are treated as non-base view images.

When multi-view images as illustrated in FIG. 30 are encoded and decoded, images of respective views are encoded and decoded, but the above-described method for encoding and decoding may be applied to encoding and decoding of each view. That is to say, motion information and the like may be shared in the plurality of views for the multi-view encoding and decoding.

For example, for the base view, a predictive image may be generated only using image information or in-screen motion information of the view itself, and for the non-base view, a predictive image may also be generated using the in-screen motion information of the base view.

With the operation described above, encoding efficiency in intra prediction of upper layers can also be improved in multi-view encoding and decoding as in the above-described layer encoding and decoding.

As described above, the present technology can be applied to all image encoding devices and all image decoding devices based on scalable encoding and decoding.

For example, the present technology can be applied to an image encoding device and an image decoding device used when image information (bitstream) compressed by an orthogonal transform such as a discrete cosine transform and motion compensation as in MPEG and H.26x is received via a network medium such as satellite broadcasting, cable television, the Internet, or a mobile telephone. Further, the present technology can be applied to an image encoding device and an image decoding device used when processing is performed on a storage medium such as an optical disc, a magnetic disk, or a flash memory.

### 4. Third Embodiment

### [Computer]

The above described series of processes can be executed by hardware or can be executed by software. When the series of processes are to be performed by software, the programs forming the software are installed into a computer. Here, a computer includes a computer which is incorporated in dedicated hardware or a general-purpose personal computer (PC) which can execute various functions by installing various programs into the computer, for example.

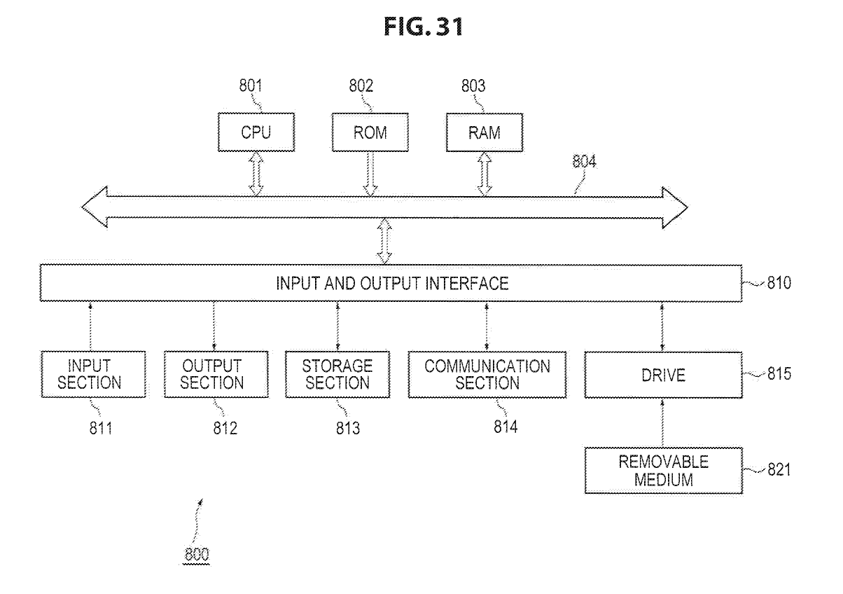

FIG. 31 is a block diagram illustrating a configuration example of hardware of a computer for executing the above-described series of processes through a program.

In a computer 800 shown in FIG. 31, a central processing unit (CPU) 801, a read only memory (ROM) 802, and a random access memory (RAM) 803 are connected to one another by a bus 804.

An input and output interface 810 is further connected to the bus 804. An input section 811, an output section 812, a storage section 813, a communication section 814, and a drive 815 are connected to the input and output interface 810.

The input section 811 is formed with a keyboard, a mouse, a microphone, a touch panel, an input terminal, and the like. The output section 812 is formed with a display, a speaker, an output terminal, and the like. The storage section 813 is formed with a hard disk, a RAM disk, a nonvolatile memory, or the like. The communication section 814 is formed with a network interface or the like. The drive 815 drives a removable medium 821 such as a magnetic disk, an optical disk, a magneto-optical disk, or a semiconductor memory.

In the computer configured as described above, the CPU 801 loads the programs stored in the storage section 813 into the RAM 803 via the input and output interface 810 and the bus 804, and executes the programs, so that the above described series of processes are performed. The RAM 803 also stores data necessary for the CPU 801 to execute the various processes.

The program executed by the computer (the CPU 801) may be provided by being recorded on the removable medium 821 as a packaged medium or the like. The program can also be applied via a wired or wireless transfer medium, such as a local area network, the Internet, or a digital satellite broadcast.

In the computer, by loading the removable medium 821 into the drive 815, the program can be installed into the storage section 813 via the input and output interface 810. It is also possible to receive the program from a wired or wireless transfer medium using the communication section 814 and install the program into the storage section 813. As another alternative, the program can be installed in advance into the ROM 802 or the storage section 813.

It should be noted that the program executed by a computer may be a program that is processed in time series according to the sequence described in this specification or a program that is processed in parallel or at necessary timing such as upon calling.

In the present disclosure, steps of describing the program to be recorded on the recording medium may include processing performed in time-series according to the description order and processing not processed in time-series but performed in parallel or individually.

In addition, in this disclosure, a system means a set of a plurality of elements (devices, modules (parts), or the like) regardless of whether or not all elements are arranged in a single housing. Thus, both a plurality of devices that are accommodated in separate housings and connected via a network and a single device in which a plurality of modules are accommodated in a single housing are systems.

Further, an element described as a single device (or processing unit) above may be divided and configured as a plurality of devices (or processing units). On the contrary, elements described as a plurality of devices (or processing units) above may be configured collectively as a single device (or processing unit). Further, an element other than those described above may be added to each device (or processing unit). Furthermore, a part of an element of a given device (or processing unit) may be included in an element of another device (or another processing unit) as long as the configuration or operation of the system as a whole is substantially the same.

The preferred embodiments of the present disclosure have been described above with reference to the accompanying drawings, whilst the present invention is not limited to the above examples, of course. A person skilled in the art may find various alterations and modifications within the scope of the appended claims, and it should be understood that they will naturally come under the technical scope of the present disclosure.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

The image encoding device and the image decoding device according to the embodiment may be applied to various electronic devices such as transmitters and receivers for satellite broadcasting, cable broadcasting such as cable TV, distribution on the Internet, distribution to terminals via cellular communication and the like, recording devices that record images in a medium such as optical discs, magnetic disks and flash memory, and reproduction devices that reproduce images from such storage medium. Four applications will be described below.

### 5. Applications

### [First Application: Television Receiver]

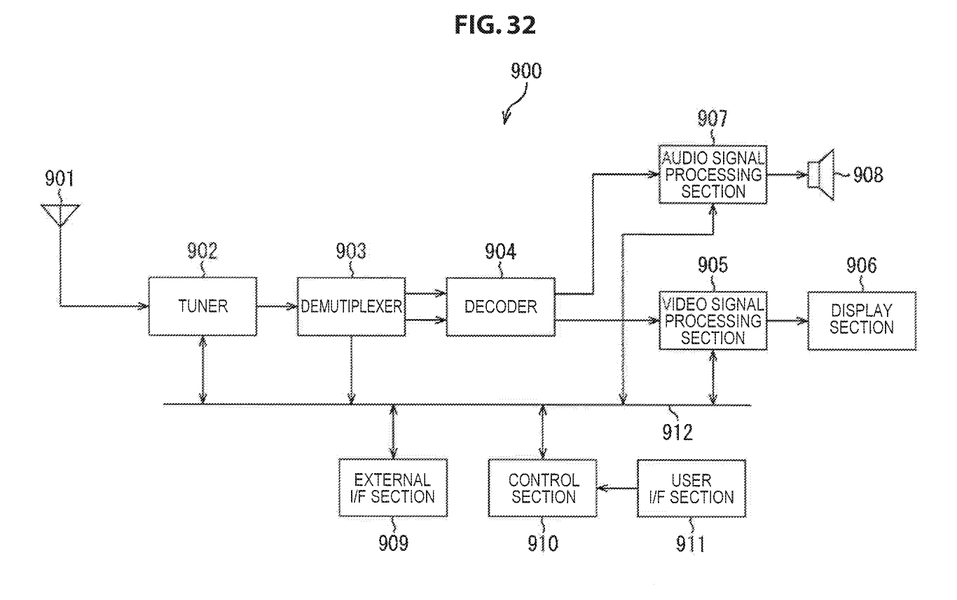

FIG. 32 illustrates an example of a schematic configuration of a television device to which the embodiment is applied. A television device 900 includes an antenna 901, a tuner 902, a demultiplexer 903, a decoder 904, an video signal processing section 905, a display section 906, an audio signal processing section 907, a speaker 908, an external interface 909, a control section 910, a user interface 911, and a bus 912.

The tuner 902 extracts a signal of a desired channel from broadcast signals received via the antenna 901, and demodulates the extracted signal. The tuner 902 then outputs an encoded bitstream obtained through the demodulation to the demultiplexer 903. That is, the tuner 902 serves as a transmission unit of the television device 900 for receiving an encoded stream in which an image is encoded.

The demultiplexer 903 demultiplexes the encoded bitstream to obtain a video stream and an audio stream of a program to be viewed, and outputs each stream obtained through the demultiplexing to the decoder 904. The demultiplexer 903 also extracts auxiliary data such as electronic program guides (EPGs) from the encoded bitstream, and supplies the extracted data to the control section 910. Additionally, the demultiplexer 903 may perform descrambling when the encoded bitstream has been scrambled.

The decoder 904 decodes the video stream and the audio stream input from the demultiplexer 903. The decoder 904 then outputs video data generated in the decoding process to the video signal processing section 905. The decoder 904 also outputs the audio data generated in the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network. Further, the video signal processing section 905 may perform an additional process such as noise removal, for example, on the video data in accordance with the setting. Furthermore, the video signal processing section 905 may generate an image of a graphical user interface (GUI) such as a menu, a button and a cursor, and superimpose the generated image on an output image.

The display section 906 is driven by a drive signal supplied from the video signal processing section 905, and displays a video or an image on a video screen of a display device (e.g. liquid crystal display, plasma display, organic electroluminescence display (OLED), etc.).

The audio signal processing section 907 performs a reproduction process such as D/A conversion and amplification on the audio data input from the decoder 904, and outputs a sound from the speaker 908. The audio signal processing section 907 may also perform an additional process such as noise removal on the audio data.

The external interface 909 is an interface for connecting the television device 900 to an external device or a network. For example, a video stream or an audio stream received via the external interface 909 may be decoded by the decoder 904. That is, the external interface 909 also serves as a transmission unit of the television device 900 for receiving an encoded stream in which an image is encoded.

The control section 910 includes a processor such as a central processing unit (CPU), and a memory such as random access memory (RAM) and read only memory (ROM). The memory stores a program to be executed by the CPU, program data, EPG data, data acquired via a network, and the like. The program stored in the memory is read out and executed by the CPU at the time of activation of the television device 900, for example. The CPU controls the operation of the television device 900, for example, in accordance with an operation signal input from the user interface 911 by executing the program.

The user interface 911 is connected to the control section 910. The user interface 911 includes, for example, a button and a switch used for a user to operate the television device 900, and a receiving section for a remote control signal. The user interface 911 detects an operation of a user via these structural elements, generates an operation signal, and outputs the generated operation signal to the control section 910.

The bus 912 connects the tuner 902, the demultiplexer 903, the decoder 904, the video signal processing section 905, the audio signal processing section 907, the external interface 909, and the control section 910 to each other.

The decoder 904 has a function of the scalable decoding device 200 according to the embodiment in the television device 900 configured in this manner. Accordingly, encoding efficiency in intra prediction of an upper layer when an image is decoded in the television device 900 can be improved.

### [Second Application: Mobile Phone]

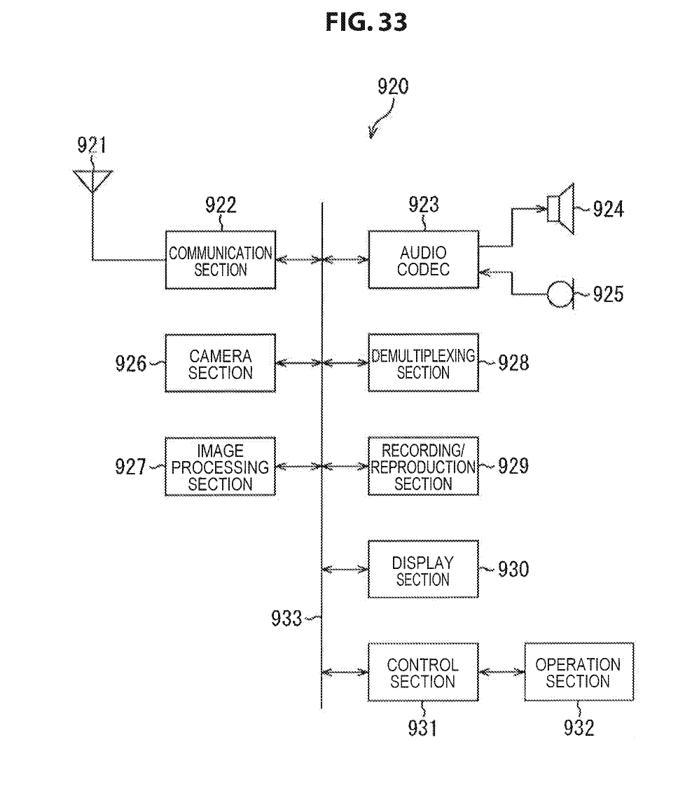

FIG. 33 illustrates an example of a schematic configuration of a mobile phone to which the embodiment is applied. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 connects the communication section 922, the audio codec 923, the camera section 926, the image processing section 927, the demultiplexing section 928, the recording/reproduction section 929, the display section 930, and the control section 931 to each other.

The mobile phone 920 performs an operation such as transmission and reception of an audio signal, transmission and reception of email or image data, image capturing, and recording of data in various operation modes including an audio call mode, a data communication mode, an image capturing mode, and a videophone mode.

An analogue audio signal generated by the microphone 925 is supplied to the audio codec 923 in the audio call mode. The audio codec 923 converts the analogue audio signal into audio data, has the converted audio data subjected to the A/D conversion, and compresses the converted data. The audio codec 923 then outputs the compressed audio data to the communication section 922. The communication section 922 encodes and modulates the audio data, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. The communication section 922 then demodulates and decodes the received signal, generates audio data, and outputs the generated audio data to the audio codec 923. The audio codec 923 extends the audio data, has the audio data subjected to the D/A conversion, and generates an analogue audio signal. The audio codec 923 then supplies the generated audio signal to the speaker 924 to output a sound.

The control section 931 also generates text data in accordance with an operation made by a user via the operation section 932, the text data, for example, composing email. Moreover, the control section 931 causes the display section 930 to display the text. Furthermore, the control section 931 generates email data in accordance with a transmission instruction from a user via the operation section 932, and outputs the generated email data to the communication section 922. The communication section 922 encodes and modulates the email data, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. The communication section 922 then demodulates and decodes the received signal to restore the email data, and outputs the restored email data to the control section 931. The control section 931 causes the display section 930 to display the content of the email, and also causes the storage medium of the recording/reproduction section 929 to store the email data.

The recording/reproduction section 929 includes a readable and writable storage medium. For example, the storage medium may be a built-in storage medium such as RAM and flash memory, or an externally mounted storage medium such as hard disks, magnetic disks, magneto-optical disks, optical discs, universal serial bus (USB) memory, and memory cards.

Furthermore, the camera section 926, for example, captures an image of a subject to generate image data, and outputs the generated image data to the image processing section 927 in the image capturing mode. The image processing section 927 encodes the image data input from the camera section 926, and causes the storage medium of the recording/reproduction section 929 to store the encoded stream.

Furthermore, the demultiplexing section 928, for example, multiplexes a video stream encoded by the image processing section 927 and an audio stream input from the audio codec 923, and outputs the multiplexed stream to the communication section 922 in the videophone mode. The communication section 922 encodes and modulates the stream, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. These transmission signal and received signal may include an encoded bitstream. The communication section 922 then demodulates and decodes the received signal to restore the stream, and outputs the restored stream to the demultiplexing section 928. The demultiplexing section 928 demultiplexes the input stream to obtain a video stream and an audio stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends the audio stream, has the audio stream subjected to the D/A conversion, and generates an analogue audio signal. The audio codec 923 then supplies the generated audio signal to the speaker 924, and causes a sound to be output.

The image processing section 927 has functions of the scalable encoding device 100 and the scalable decoding device 200 according to the embodiment in the mobile phone 920 configured in this manner. Accordingly, encoding efficiency in intra prediction of an upper layer when an image is encoded and decoded in the mobile phone 920 can be improved.

### [Third Application: Recording/Reproduction Device]

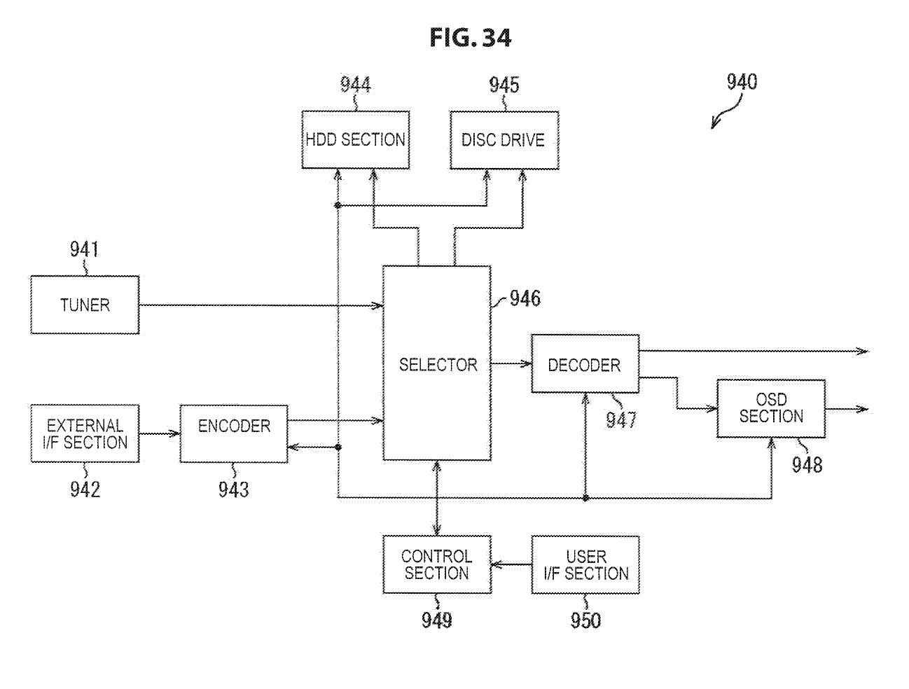

FIG. 34 illustrates an example of a schematic configuration of a recording/reproduction device to which the embodiment is applied. A recording/reproduction device 940, for example, encodes audio data and video data of a received broadcast program and records the encoded audio data and the encoded video data in a recording medium. For example, the recording/reproduction device 940 may also encode audio data and video data acquired from another device and record the encoded audio data and the encoded video data in a recording medium. Furthermore, the recording/reproduction device 940, for example, uses a monitor or a speaker to reproduce the data recorded in the recording medium in accordance with an instruction of a user. At this time, the recording/reproduction device 940 decodes the audio data and the video data.

The recording/reproduction device 940 includes a tuner 941, an external interface 942, an encoder 943, a hard disk drive (HDD) 944, a disc drive 945, a selector 946, a decoder 947, an on-screen display (OSD) 948, a control section 949, and a user interface 950.

The tuner 941 extracts a signal of a desired channel from broadcast signals received via an antenna (not shown), and demodulates the extracted signal. The tuner 941 then outputs an encoded bitstream obtained through the demodulation to the selector 946. That is, the tuner 941 serves as a transmission unit of the recording/reproduction device 940.

The external interface 942 is an interface for connecting the recording/reproduction device 940 to an external device or a network. For example, the external interface 942 may be an IEEE 1394 interface, a network interface, an USB interface, a flash memory interface, or the like. For example, video data and audio data received via the external interface 942 are input to the encoder 943. That is, the external interface 942 serves as a transmission unit of the recording/reproduction device 940.

When the video data and the audio data input from the external interface 942 have not been encoded, the encoder 943 encodes the video data and the audio data. The encoder 943 then outputs an encoded bitstream to the selector 946.

The HDD 944 records, in an internal hard disk, the encoded bitstream in which content data of a video and a sound is compressed, various programs, and other pieces of data. The HDD 944 also reads out these pieces of data from the hard disk at the time of reproducing a video or a sound.

The disc drive 945 records and reads out data in a recording medium that is mounted. The recording medium that is mounted on the disc drive 945 may be, for example, a DVD disc (DVD-Video, DVD-RAM, DVD-R, DVD-RW, a DVD+R, DVD+RW, etc.), a Blu-ray (registered trademark) disc, or the like.

The selector 946 selects, at the time of recording a video or a sound, an encoded bitstream input from the tuner 941 or the encoder 943, and outputs the selected encoded bitstream to the HDD 944 or the disc drive 945. The selector 946 also outputs, at the time of reproducing a video or a sound, an encoded bitstream input from the HDD 944 or the disc drive 945 to the decoder 947.

The decoder 947 decodes the encoded bitstream, and generates video data and audio data. The decoder 947 then outputs the generated video data to the OSD 948. The decoder 904 also outputs the generated audio data to an external speaker.

The OSD 948 reproduces the video data input from the decoder 947, and displays a video. The OSD 948 may also superimpose an image of a GUI such as a menu, a button, and a cursor on a displayed video.

The control section 949 includes a processor such as a CPU, and a memory such as RAM and ROM. The memory stores a program to be executed by the CPU, program data, and the like. For example, a program stored in the memory is read out and executed by the CPU at the time of activation of the recording/reproduction device 940. The CPU controls the operation of the recording/reproduction device 940, for example, in accordance with an operation signal input from the user interface 950 by executing the program.

The user interface 950 is connected to the control section 949. The user interface 950 includes, for example, a button and a switch used for a user to operate the recording/reproduction device 940, and a receiving section for a remote control signal. The user interface 950 detects an operation made by a user via these structural elements, generates an operation signal, and outputs the generated operation signal to the control section 949.

The encoder 943 has a function of the scalable encoding device 100 according to the embodiment in the recording/reproduction device 940 configured in this manner. The decoder 947 also has a function of the scalable decoding device 200 according to the embodiment. Accordingly, encoding efficiency in intra prediction of an upper layer when an image is encoded and decoded in the recording/reproduction device 940 can be improved.

### [Fourth Application: Image Capturing Device]

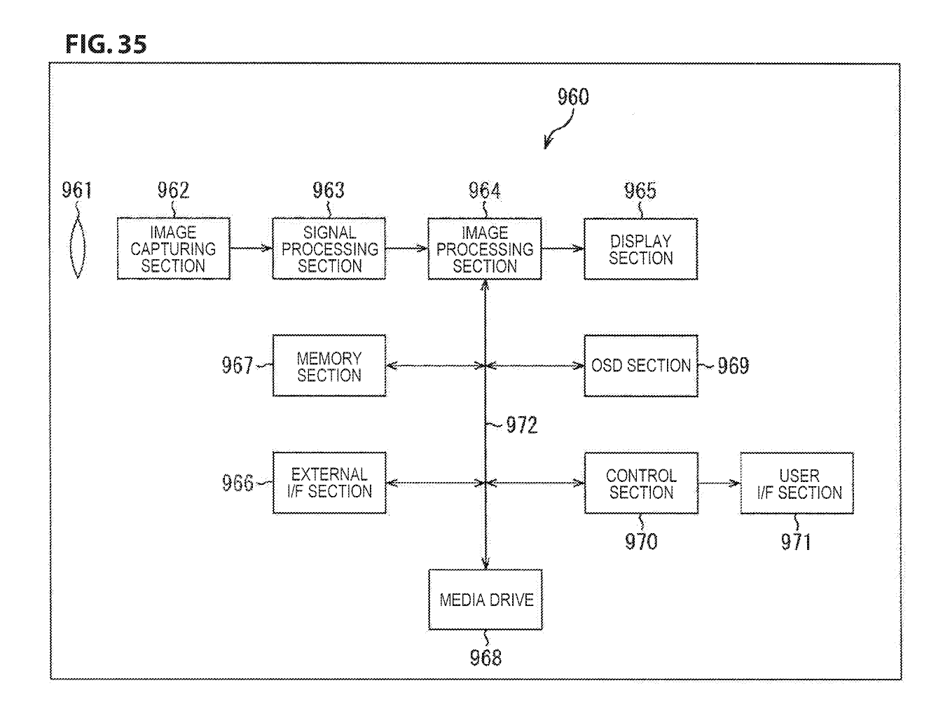

FIG. 35 illustrates an example of a schematic configuration of an image capturing device to which the embodiment is applied. An image capturing device 960 captures an image of a subject to generate an image, encodes the image data, and records the image data in a recording medium.

The image capturing device 960 includes an optical block 961, an image capturing section 962, a signal processing section 963, an image processing section 964, a display section 965, an external interface 966, a memory 967, a media drive 968, an OSD 969, a control section 970, a user interface 971, and a bus 972.

The optical block 961 is connected to the image capturing section 962. The image capturing section 962 is connected to the signal processing section 963. The display section 965 is connected to the image processing section 964. The user interface 971 is connected to the control section 970. The bus 972 connects the image processing section 964, the external interface 966, the memory 967, the media drive 968, the OSD 969, and the control section 970 to each other.

The optical block 961 includes a focus lens, an aperture stop mechanism, and the like. The optical block 961 forms an optical image of a subject on an image capturing surface of the image capturing section 962. The image capturing section 962 includes an image sensor such as a charge coupled device (CCD) and a complementary metal oxide semiconductor (CMOS), and converts the optical image formed on the image capturing surface into an image signal which is an electrical signal through photoelectric conversion. The image capturing section 962 then outputs the image signal to the signal processing section 963.

The signal processing section 963 performs various camera signal processes such as knee correction, gamma correction, and color correction on the image signal input from the image capturing section 962. The signal processing section 963 outputs the image data subjected to the camera signal process to the image processing section 964.

The image processing section 964 encodes the image data input from the signal processing section 963, and generates encoded data. The image processing section 964 then outputs the generated encoded data to the external interface 966 or the media drive 968. The image processing section 964 also decodes encoded data input from the external interface 966 or the media drive 968, and generates image data. The image processing section 964 then outputs the generated image data to the display section 965. The image processing section 964 may also output the image data input from the signal processing section 963 to the display section 965, and cause the image to be displayed. Furthermore, the image processing section 964 may superimpose data for display acquired from the OSD 969 on an image to be output to the display section 965.

The OSD 969 generates an image of a GUI such as a menu, a button, and a cursor, and outputs the generated image to the image processing section 964.

The external interface 966 is configured, for example, as an USB input and output terminal. The external interface 966 connects the image capturing device 960 and a printer, for example, at the time of printing an image. A drive is further connected to the external interface 966 as needed. A removable medium such as magnetic disks and optical discs is mounted on the drive, and a program read out from the removable medium may be installed in the image capturing device 960. Furthermore, the external interface 966 may be configured as a network interface to be connected to a network such as a LAN and the Internet. That is, the external interface 966 serves as a transmission unit of the image capturing device 960.

A recording medium to be mounted on the media drive 968 may be a readable and writable removable medium such as magnetic disks, magneto-optical disks, optical discs, and semiconductor memory. The recording medium may also be fixedly mounted on the media drive 968, configuring a non-transportable storage section such as built-in hard disk drives or solid state drives (SSDs).

The control section 970 includes a processor such as a CPU, and a memory such as a RAM and a ROM. The memory stores a program to be executed by the CPU, program data, and the like. A program stored in the memory is read out and executed by the CPU, for example, at the time of activation of the image capturing device 960. The CPU controls the operation of the image capturing device 960, for example, in accordance with an operation signal input from the user interface 971 by executing the program.

The user interface 971 is connected to the control section 970. The user interface 971 includes, for example, a button, a switch, and the like used for a user to operate the image capturing device 960. The user interface 971 detects an operation made by a user via these structural elements, generates an operation signal, and outputs the generated operation signal to the control section 970.

The image processing section 964 has a function of the scalable encoding device 100 and the scalable decoding device 200 according to the embodiment in the image capturing device 960 configured in this manner. Accordingly, encoding efficiency in intra prediction of an upper layer when an image is encoded and decoded in the image capturing device 960 can be improved.

### 6. Application Example of Scalable Video Coding

### [First System]

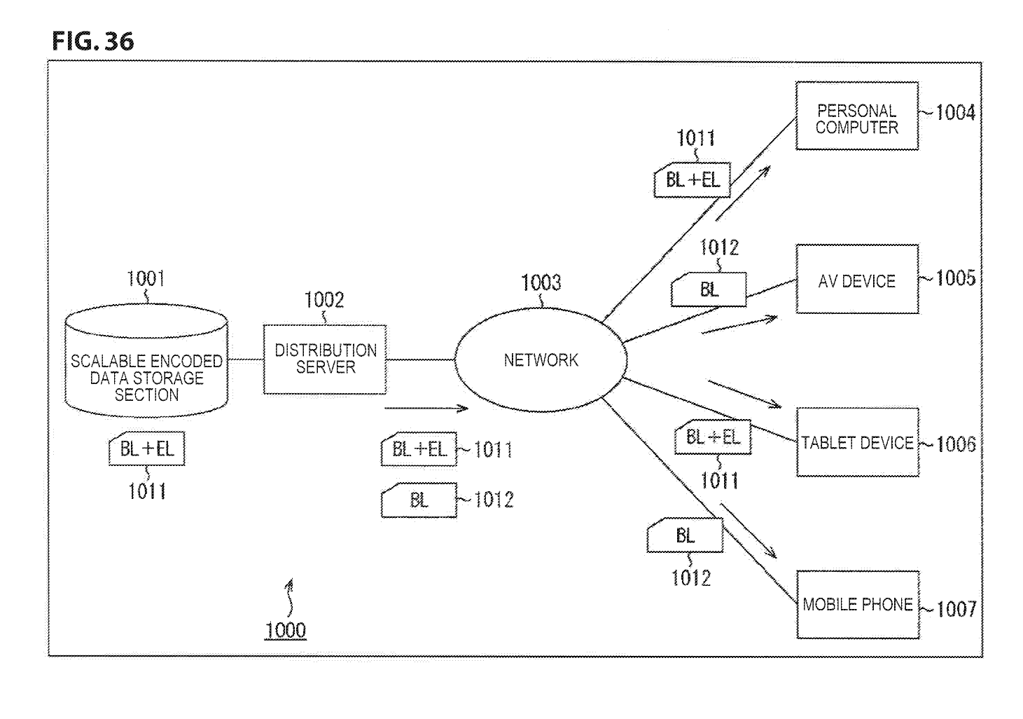

Next, a specific example of using scalable encoded data, in which a scalable video coding is performed, will be described. The scalable video coding, for example, is used for selection of data to be transmitted as examples illustrated in FIG. 36.

In a data transmission system 1000 illustrated in FIG. 36, a distribution server 1002 reads scalable encoded data stored in a scalable encoded data storage section 1001, and distributes the scalable encoded data to a terminal device such as a personal computer 1004, an AV device 1005, a tablet device 1006, or a mobile phone 1007 via a network 1003.

At this time, the distribution server 1002 selects and transmits encoded data having proper quality according to capability of the terminal device, communication environment, or the like. Even when the distribution server 1002 transmits unnecessarily high-quality data, a high-quality image is not necessarily obtainable in the terminal device and it may be a cause of occurrence of a delay or an overflow. In addition, a communication band may be unnecessarily occupied or a load of the terminal device may be unnecessarily increased. In contrast, even when the distribution server 1002 transmits unnecessarily low quality data, an image with a sufficient quality may not be obtained. Thus, the distribution server 1002 appropriately reads and transmits the scalable encoded data stored in the scalable encoded data storage section 1001 as the encoded data having a proper quality according to the capability of the terminal device, the communication environment, or the like.

For example, the scalable encoded data storage section 1001 is configured to store scalable encoded data (BL+EL) 1011 in which the scalable video coding is performed. The scalable encoded data (BL+EL) 1011 is encoded data including both a base layer and an enhancement layer, and is data from which a base layer image and an enhancement layer image can be obtained by performing decoding.

The distribution server 1002 selects an appropriate layer according to the capability of the terminal device for transmitting data, the communication environment, or the like, and reads the data of the selected layer. For example, with respect to the personal computer 1004 or the tablet device 1006 having high processing capability, the distribution server 1002 reads the scalable encoded data (BL+EL) 1011 from the scalable encoded data storage section 1001, and transmits the scalable encoded data (BL+EL) 1011 without change. On the other hand, for example, with respect to the AV device 1005 or the mobile phone 1007 having low processing capability, the distribution server 1002 extracts the data of the base layer from the scalable encoded data (BL+EL) 1011, and transmits the extracted data of the base layer as low quality scalable encoded data (BL) 1012 that is data having the same content as the scalable encoded data (BL+EL) 1011 but has lower quality than the scalable encoded data (BL+EL) 1011.

Because an amount of data can easily be adjusted by employing the scalable encoded data, the occurrence of the delay or the overflow can be suppressed or the unnecessary increase of the load of the terminal device or the communication media can be suppressed. In addition, because a redundancy between the layers is reduced in the scalable encoded data (BL+EL) 1011, it is possible to further reduce the amount of data than when the encoded data of each layer is treated as the individual data. Therefore, it is possible to more efficiently use the storage region of the scalable encoded data storage section 1001.

Because various devices such as the personal computer 1004 to the mobile phone 1007 are applicable as the terminal device, the hardware performance of the terminal devices differs according to the device. In addition, because there are various applications which are executed by the terminal device, the software performance thereof also varies. Further, because all the communication networks including a wired, wireless, or both such as the Internet and the local area network (LAN) are applicable as the network 1003 serving as a communication medium, the data transmission performance thereof varies. Further, the data transmission performance may vary by other communications, or the like.

Therefore, the distribution server 1002 may perform communication with the terminal device which is the data transmission destination before starting the data transmission, and then obtain information related to the terminal device performance such as hardware performance of the terminal device, or the application (software) performance which is executed by the terminal device, and information related to the communication environment such as an available bandwidth of the network 1003. Then, distribution server 1002 may select an appropriate layer based on the obtained information.

Also, the extraction of the layer may be performed in the terminal device. For example, the personal computer 1004 may decode the transmitted scalable encoded data (BL+EL) 1011 and display the image of the base layer or display the image of the enhancement layer. In addition, for example, the personal computer 1004 may be configured to extract the scalable encoded data (BL) 1012 of the base layer from the transmitted scalable encoded data (BL+EL) 1011, store the extracted scalable encoded data (BL) 1012 of the base layer, transmit to another device, or decode and display the image of the base layer.

Of course, the number of the scalable encoded data storage sections 1001, the distribution servers 1002, the networks 1003, and the terminal devices are optional. In addition, although the example of the distribution server 1002 transmitting the data to the terminal device is described above, the example of use is not limited thereto. The data transmission system 1000 is applicable to any system which selects and transmits an appropriate layer according to the capability of the terminal device, the communication environment, or the like when the scalable encoded data is transmitted to the terminal device.

In addition, by applying the present technology to the data transmission system 1000 described above in the same way as the application to the layer encoding and layer decoding in the first and second embodiments described above, the same effect as in the first and second embodiments can be obtained.

### [Second System]

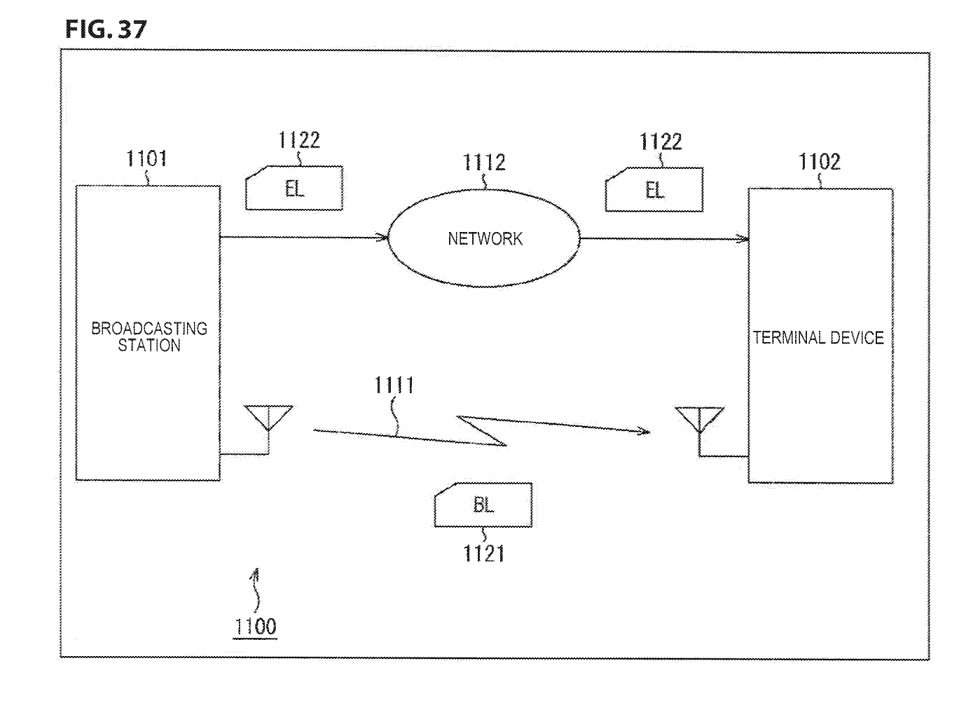

In addition, the scalable video coding, for example, is used for transmission via a plurality of communication media as in an example illustrated in FIG. 37.

In a data transmission system 1100 illustrated in FIG. 37, a broadcasting station 1101 transmits scalable encoded data (BL) 1121 of the base layer by terrestrial broadcasting 1111. In addition, the broadcasting station 1101 transmits scalable encoded data (EL) 1122 of the enhancement layer via any arbitrary network 1112 made of a communication network that is wired, wireless, or both (for example, the data is packetized and transmitted).

A terminal device 1102 has a function of receiving the terrestrial broadcasting 1111 that is broadcast by the broadcasting station 1101 and receives the scalable encoded data (BL) 1121 of the base layer transmitted via the terrestrial broadcasting 1111. In addition, the terminal device 1102 further has a communication function by which the communication is performed via the network 1112, and receives the scalable encoded data (EL) 1122 of the enhancement layer transmitted via the network 1112.

For example, according to a user's instruction or the like, the terminal device 1102 decodes the scalable encoded data (BL) 1121 of the base layer acquired via the terrestrial broadcasting 1111, thereby obtaining or storing the image of the base layer or transmitting the image of the base layer to other devices.

In addition, for example, according to the user's instruction, the terminal device 1102 combines the scalable encoded data (BL) 1121 of the base layer acquired via the terrestrial broadcasting 1111 and the scalable encoded data (EL) 1122 of the enhancement layer acquired via the network 1112, thereby obtaining the scalable encoded data (BL+EL), obtaining or storing the image of the enhancement layer by decoding the scalable encoded data (BL+EL), or transmitting the image of the enhancement layer to other devices.

As described above, the scalable encoded data, for example, can be transmitted via the different communication medium for each layer. Therefore, it is possible to disperse the load and suppress the occurrence of the delay or the overflow.

In addition, according to the situation, the communication medium used for the transmission for each layer may be configured to be selected. For example, the scalable encoded data (BL) 1121 of the base layer in which the amount of data is comparatively large may be transmitted via the communication medium having a wide bandwidth, and the scalable encoded data (EL) 1122 of the enhancement layer in which the amount of data is comparatively small may be transmitted via the communication media having a narrow bandwidth. In addition, for example, whether the communication medium that transmits the scalable encoded data (EL) 1122 of the enhancement layer is the network 1112 or the terrestrial broadcasting 1111 may be switched according to the available bandwidth of the network 1112. Of course, the same is true for data of an arbitrary layer.

By controlling in this way, it is possible to further suppress the increase of the load in the data transmission.

Of course, the number of the layers is optional, and the number of communication media used in the transmission is also optional. In addition, the number of terminal devices 1102 which are the destination of the data distribution is also optional. Further, although the example of the broadcasting from the broadcasting station 1101 has been described above, the use example is not limited thereto. The data transmission system 1100 can be applied to any system which divides the scalable encoded data using a layer as a unit and transmits the scalable encoded data via a plurality of links.

In addition, by applying the present technology to the data transmission system 1100 described above in the same way as the application to the layer encoding and layer decoding in the first and second embodiments described above, the same effect as in the first and second embodiments can be obtained.

### [Third System]

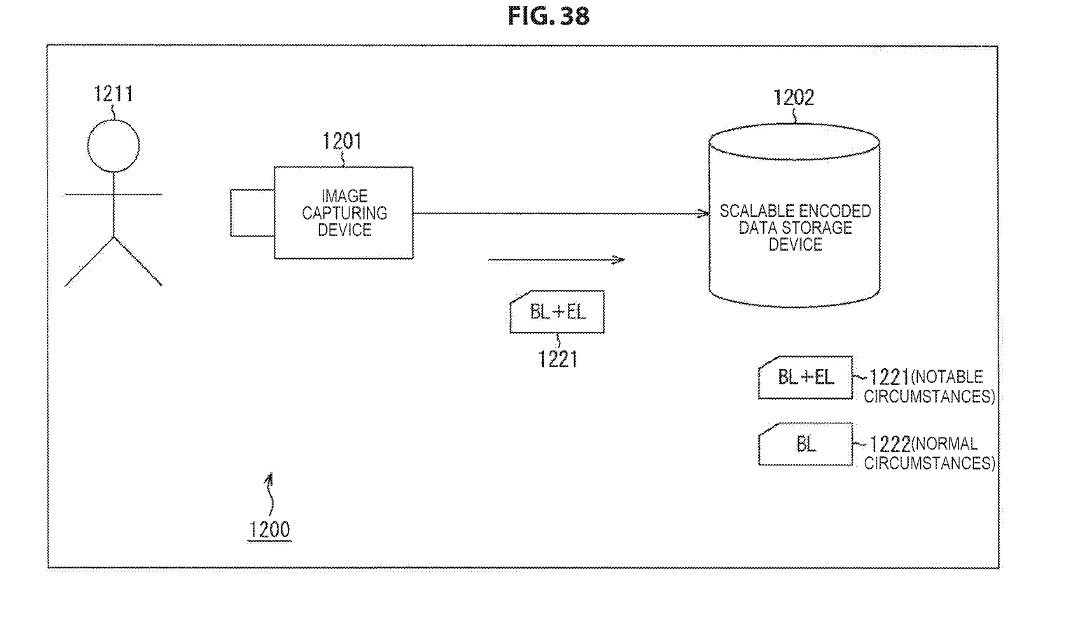

In addition, the scalable video coding is used in the storage of the encoded data as an example illustrated in FIG. 38.

In an image capturing system 1200 illustrated in FIG. 38, an image capturing device 1201 performs scalable video coding on image data obtained by capturing an image of a subject 1211, and supplies a scalable video result as the scalable encoded data (BL+EL) 1221 to a scalable encoded data storage device 1202.

The scalable encoded data storage device 1202 stores the scalable encoded data (BL+EL) 1221 supplied from the image capturing device 1201 in quality according to the situation. For example, in the case of normal circumstances, the scalable encoded data storage device 1202 extracts data of the base layer from the scalable encoded data (BL+EL) 1221, and stores the extracted data as scalable encoded data (BL) 1222 of the base layer having a small amount of data at low quality. On the other hand, for example, in the case of notable circumstances, the scalable encoded data storage device 1202 stores the scalable encoded data (BL+EL) 1221 having a large amount of data at high quality without change.

In this way, because the scalable encoded data storage device 1202 can save the image at high quality only in a necessary case, it is possible to suppress the decrease of the value of the image due to the deterioration of the image quality and suppress the increase of the amount of data, and it is possible to improve the use efficiency of the storage region.

For example, the image capturing device 1201 is assumed to be a motoring camera. Because content of the captured image is unlikely to be important when a monitoring subject (for example, an invader) is not shown in the imaged image (in the case of the normal circumstances), the priority is on the reduction of the amount of data, and the image data (scalable encoded data) is stored at low quality. On the other hand, because the content of the imaged image is likely to be important when a monitoring target is shown as the subject 1211 in the imaged image (in the case of the notable circumstances), the priority is on the image quality, and the image data (scalable encoded data) is stored at high quality.

For example, whether the case is the case of the normal circumstances or the notable circumstances may be determined by the scalable encoded data storage device 1202 by analyzing the image. In addition, the image capturing device 1201 may be configured to make the determination and transmit the determination result to the scalable encoded data storage device 1202.

A determination criterion of whether the case is the case of the normal circumstances or the notable circumstances is optional and the content of the image which is the determination criterion is optional. Of course, a condition other than the content of the image can be designated as the determination criterion. For example, switching may be configured to be performed according to the magnitude or waveform of recorded sound, by a predetermined time interval, or by an external instruction such as the user's instruction.

In addition, although the two states of the normal circumstances and the notable circumstances have been described above, the number of the states is optional, and for example, switching may be configured to be performed among three or more states such as normal circumstances, slightly notable circumstances, notable circumstances, and highly notable circumstances. However, the upper limit number of states to be switched depends upon the number of layers of the scalable encoded data.

In addition, the image capturing device 1201 may determine the number of layers of the scalable video coding according to the state. For example, in the case of the normal circumstances, the image capturing device 1201 may generate the scalable encoded data (BL) 1222 of the base layer having a small amount of data at low quality and supply the data to the scalable encoded data storage device 1202. In addition, for example, in the case of the notable circumstances, the image capturing device 1201 may generate the scalable encoded data (BL+EL) 1221 of the base layer having a large amount of data at high quality and supply the data to the scalable encoded data storage device 1202.

Although the monitoring camera has been described above as the example, the usage of the image capturing system 1200 is optional and is not limited to the monitoring camera.

In addition, by applying the present technology to the image capturing system 1200 described above in the same way as the application to the layer encoding and layer decoding in the first and second embodiments described above, the same effect as in the first and second embodiments can be obtained.

Further, the present technology can also be applied to HTTP streaming such as MPEG DASH in which appropriate encoded data is selected in units of segments from among a plurality of pieces of encoded data having different solutions that are prepared in advance and used. In other words, a plurality of pieces of encoded data can share information related to encoding or decoding.

Further, in this specification, the example in which various kinds of information are multiplexed into an encoded stream and transmitted from the encoding side to the decoding side has been described. However, a technique of transmitting the information is not limited to this example. For example, the information may be transmitted or recorded as individual data associated with an encoded bitstream without being multiplexed in the encoded stream. Here, the term “associate” refers to that an image included in the bitstream (which may be part of an image such a slice or a block) and information corresponding to the image is configured to be linked at the time of decoding. That is, the information may be transmitted on a separate transmission path from an image (or bitstream). In addition, the information may be recorded on a separate recording medium (or a separate recording area of the same recording medium) from the image (or bitstream). Further, the information and the image (or the bitstream), for example, may be associated with each other in an arbitrary unit such as a plurality of frames, one frame, or a portion within the frame.

The preferred embodiments of the present disclosure have been described above with reference to the accompanying drawings, whilst the present invention is not limited to the above examples, of course. A person skilled in the art may find various alterations and modifications within the scope of the appended claims, and it should be understood that they will naturally come under the technical scope of the present disclosure.

Additionally, the present technology may also be configured as below.

(1)

An image processing device including:

an in-screen search section configured to detect, with respect to an image of a lower layer of a current layer, a corresponding block which corresponds to a current block of the current layer and to perform an in-screen motion search on the detected corresponding block; and

an intra prediction section configured to generate a predictive image of the current block using information of the in-screen motion searched for by the in-screen search section.

(2)

The image processing device according to (1), wherein a mode of the in-screen motion search is used in encoding as one intra prediction mode of candidate predictions.

(3)

The image processing device according to (1) or (2), wherein a method for the in-screen motion search is block matching.

(4)

The image processing device according to any of (1) to (3), wherein a search range of the in-screen motion search is transmitted along with layer image encoded data obtained by encoding image data hierarchized into a plurality of layers.

(5)

The image processing device according to any of (1) to (4), wherein the search range of the in-screen motion search is transmitted in a sequence parameter set (SPS).

(6)

The image processing device according to any of (1) to (4), wherein the search range of the in-screen motion search is transmitted in a picture parameter set (PPS).

(7)

The image processing device according to any of (1) to (4), wherein the search range of the in-screen motion search is transmitted in a slice header.

(8)

The image processing device according to any of (1) to (7), wherein the in-screen search section performs an in-screen motion search on the corresponding block of the image of the lower layer that has not undergone up-sampling.

(9)

The image processing device according to (8), wherein the in-screen search section performs scaling on in-screen motion information obtained from the in-screen motion search, according to resolution of the current layer.

(10)

The image processing device according to any of (1) to (7), wherein the in-screen search section performs an in-screen motion search on the corresponding block of the image of the lower layer that has undergone up-sampling.

(11)

The image processing device according to any of (1) to (10), wherein the in-screen search section performs a search for decimal pixel accuracy when the in-screen motion search is performed on the corresponding block of the image of the lower layer.

(12)

The image processing device according to (11), wherein an interpolation filter for motion compensation defined in an HEVC scheme is used in the search for the decimal pixel accuracy.

(13)

The image processing device according to any of (1) to (12), wherein the image is an image of a luminance signal.

(14)

The image processing device according to any of (1) to (13), wherein the image is an image of a luminance signal and an image of a color difference signal, which are processed separately.

(15)

The image processing device according to any of (1) to (13), wherein the image is an image of a luminance signal and an image of a color difference signal, and in-screen motion information detected using the image of the luminance signal is used in processing of the image of the color difference signal.

(16)

The image processing device according to any of (1) to (15), wherein the image is images of a Cb signal and a Cr signal, which are processed separately.

(17)

The image processing device according to any of (1) to (15), wherein the image is images of a Cb signal and a Cr signal, and in-screen motion information detected using the image of the Cb signal is used in processing of the image of the Cr signal.

(18)

The image processing device according to any of (1) to (17), wherein the information of the in-screen motion searched for by the in-screen search section is transmitted along with layer image encoded data obtained by encoding image data hierarchized into a plurality of layers.

(19)

The image processing device according to any of (1) to (17), wherein differential in-screen motion information between the information of the in-screen motion searched for by the in-screen search section and information of an in-screen motion to be used in a decoding process is transmitted along with layer image encoded data obtained by encoding image data hierarchized into a plurality of layers.

(20)

An image processing method including, by an image processing device:

detecting, with respect to an image of a lower layer of a current layer, a corresponding block which corresponds to a current block of the current layer and performing an in-screen motion search on the detected corresponding block; and generating a predictive image of the current block using information of the in-screen motion that has been searched for.

### REFERENCE SIGNS LIST

100 scalable encoding device
101 common information generation section
102 encoding control section
103 base layer image encoding section
104 in-screen motion search section
105 enhancement layer image encoding section
116 lossless encoding section
122 frame memory
124 intra prediction section
134 intra prediction section
151 address register
152 in-screen motion compensation section
153 cost function computation section
154 mode determination section
161 ColBase detection section
162 block matching section
163 base layer decoded image memory
164 scaling section
165 up-sampling section
200 scalable decoding device
201 common information acquisition section
202 decoding control section
203 base layer image decoding section
204 in-screen motion search section
205 enhancement layer image decoding section
212 lossless decoding section
219 frame memory
221 intra prediction section
231 intra prediction section
251 address register
252 prediction mode buffer
253 in-screen motion compensation section
261 ColBase detection section
262 block matching section
263 base layer decoded image memory
264 scaling section
265 up-sampling section

1. An image processing device comprising:
an in-screen search section configured to detect, with respect to an image of a lower layer of a current layer, a corresponding block which corresponds to a current block of the current layer and to perform an in-screen motion search on the detected corresponding block; and
an intra prediction section configured to generate a predictive image of the current block using information of the in-screen motion searched for by the in-screen search section.

2. The image processing device according to claim 1, wherein a mode of the in-screen motion search is used in encoding as one intra prediction mode of candidate predictions.

3. The image processing device according to claim 2, wherein a method for the in-screen motion search is block matching.

4. The image processing device according to claim 3, wherein a search range of the in-screen motion search is transmitted along with layer image encoded data obtained by encoding image data hierarchized into a plurality of layers.

5. The image processing device according to claim 4, wherein the search range of the in-screen motion search is transmitted in a sequence parameter set (SPS).

6. The image processing device according to claim 4, wherein the search range of the in-screen motion search is transmitted in a picture parameter set (PPS).

7. The image processing device according to claim 4, wherein the search range of the in-screen motion search is transmitted in a slice header.

8. The image processing device according to claim 1, wherein the in-screen search section performs an in-screen motion search on the corresponding block of the image of the lower layer that has not undergone up-sampling.

9. The image processing device according to claim 8, wherein the in-screen search section performs scaling on in-screen motion information obtained from the in-screen motion search, according to resolution of the current layer.

10. The image processing device according to claim 1, wherein the in-screen search section performs an in-screen motion search on the corresponding block of the image of the lower layer that has undergone up-sampling.

11. The image processing device according to claim 1, wherein the in-screen search section performs a search for decimal pixel accuracy when the in-screen motion search is performed on the corresponding block of the image of the lower layer.

12. The image processing device according to claim 11, wherein an interpolation filter for motion compensation defined in an HEVC scheme is used in the search for the decimal pixel accuracy.

13. The image processing device according to claim 1, wherein the image is an image of a luminance signal.

14. The image processing device according to claim 13, wherein the image is an image of a luminance signal and an image of a color difference signal, which are processed separately.

15. The image processing device according to claim 13, wherein the image is an image of a luminance signal and an image of a color difference signal, and in-screen motion information detected using the image of the luminance signal is used in processing of the image of the color difference signal.

16. The image processing device according to claim 14, wherein the image is images of a Cb signal and a Cr signal, which are processed separately.

17. The image processing device according to claim 14, wherein the image is images of a Cb signal and a Cr signal, and in-screen motion information detected using the image of the Cb signal is used in processing of the image of the Cr signal.

18. The image processing device according to claim 1, wherein the information of the in-screen motion searched for by the in-screen search section is transmitted along with layer image encoded data obtained by encoding image data hierarchized into a plurality of layers.

19. The image processing device according to claim 1, wherein differential in-screen motion information between the information of the in-screen motion searched for by the in-screen search section and information of an in-screen motion to be used in a decoding process is transmitted along with layer image encoded data obtained by encoding image data hierarchized into a plurality of layers.

20. An image processing method comprising, by an image processing device:
detecting, with respect to an image of a lower layer of a current layer, a corresponding block which corresponds to a current block of the current layer and performing an in-screen motion search on the detected corresponding block; and
generating a predictive image of the current block using information of the in-screen motion that has been searched for.
